(19) United States
(12) Patent Application Publication
(10) Pub. No.: US 2025/0164050 A1
(43) Pub. Date: May 22, 2025

(54) MEMBER, METHOD OF MANUFACTURING THE MEMBER, AND APPARATUS

(71) Applicant: CANON KABUSHIKI KAISHA, Tokyo (JP)

(72) Inventors: HIROKI WAKAYAMA, Kanagawa (JP); WATARU KIKUCHI, Saitama (JP); TAKANORI KAWANO, Saitama (JP)

(21) Appl. No.: 18/947,871

(22) Filed: Nov. 14, 2024

(30) Foreign Application Priority Data
Nov. 17, 2023 (JP) 2023-196162

(51) Int. Cl. F16L 37/084; F16L 13/02; F16L 13/10; G02B 7/10

(52) U.S. Cl. CPC F16L 37/0845; F16L 13/0218; F16L 13/103; G02B 7/10

(57) ABSTRACT

A member includes a first tubular component including a tubular portion having a tubular shape, and a second tubular component including a tubular portion having a tubular shape and disposed coaxially with the first tubular component. The first tubular component includes a plurality of projecting portions configured to project from one end of the tubular portion of the first tubular component in an axial direction and spaced from each other in a circumferential direction. The first tubular component and the second tubular component are joined with each other such that each of the plurality of projecting portions is joined with the second tubular component. Each of the plurality of projecting portions includes a distal end portion joined with the second tubular component and a base portion separated from the second tubular component.

### BACKGROUND OF THE DISCLOSURE

### Field of the Disclosure

The present disclosure relates to a member in which two components are joined with each other, a method of manufacturing the member, and an apparatus.

### Description of the Related Art

Telephoto lenses that are interchangeable lenses used for digital cameras and that have a focal length of 300 mm or more are heavy because their lens barrels are made of aluminum alloy or magnesium alloy. Such a telephoto lens is required to have high strength and light weight for improving portability and operability for taking pictures. For this reason, the development for reducing the weight and increasing the strength is in progress. For example, thermoplastic resin is used for the lens barrel or the hood for reducing the weight, and carbon-fiber reinforced resin that contains carbon fiber is used for the lens barrel or the hood for increasing the strength.

Each of the lens barrel and the hood is required to have a complicated shape for attaching the component to another component. Thus, in the manufacturing, it is difficult to achieve the shape of the component that is a single component. Japanese Patent Application Publication No. 2019-194018 proposes a technique in which a cylindrical joined member, such as a lens barrel or a hood, is manufactured by combining a plurality of resin components with each other. In the technique proposed by Japanese Patent Application Publication No. 2019-194018, a cylindrical component that contains continuous carbon fiber and thermoplastic resin is inserted into a mold, and thermoplastic resin having a high temperature is caused to flow into the mold. As a result, a cylindrical molded resin product is formed and joined with the cylindrical component, so that a joined member in which the two cylindrical components are joined with each other is manufactured.

### SUMMARY OF THE DISCLOSURE

According to a first aspect of the present disclosure, a member includes a first tubular component including a tubular portion having a tubular shape, and a second tubular component including a tubular portion having a tubular shape and disposed coaxially with the first tubular component. The first tubular component includes a plurality of projecting portions configured to project from one end of the tubular portion of the first tubular component in an axial direction and spaced from each other in a circumferential direction. The first tubular component and the second tubular component are joined with each other such that each of the plurality of projecting portions is joined with the second tubular component. Each of the plurality of projecting portions includes a distal end portion joined with the second tubular component and a base portion separated from the second tubular component.

According to a second aspect of the present disclosure, a method of manufacturing a member includes providing a first tubular component including a tubular portion having a tubular shape and a second tubular component including a tubular portion having a tubular shape and disposed coaxially with the first tubular component, the first tubular component including a plurality of projecting portions projecting from one end of the tubular portion of the first tubular component in an axial direction and spaced from each other in a circumferential direction, and joining each of the plurality of projecting portions with the second tubular component such that a distal end portion of each of the plurality of projecting portions is joined with the second tubular component and a base portion of each of the plurality of projecting portions is separated from the second tubular component.

According to a third aspect of the present disclosure, a member includes a base component, a first tubular component that has a tubular shape, that includes a tubular portion including a first end surface, and that is supported by the base component, and a second tubular component that has a tubular shape, that includes a tubular portion including a second end surface, that is made of a material whose coefficient of linear expansion is higher than that of the first tubular component, and that is supported by the base component. One of the tubular portion of the first tubular component or the tubular portion of the second tubular component includes a projection portion that projects from the first end surface or the second end surface. The other of the one of the tubular portion of the first tubular component or the tubular portion of the second tubular component includes a recess portion that is recessed from the first end surface or the second end surface, and that is in contact with the projection portion at at least two positions. The first tubular component and the second tubular component are joined with each other such that a first clearance is formed between the first end surface and the second end surface for allowing relative movement between the first end surface and the second end surface in a direction in which the first end surface and the second end surface face each other, in a case where the base component and the second tubular component relatively expand or contract with respect to the first tubular component due to change in temperature, and a contact state between the projection portion and the recess portion is kept even if the first end surface and the second end surface are relatively moved with respect to each other in the direction in which the first end surface and the second end surface face each other, by one of the projection portion and the recess portion expanding or contracting with respect to another.

According to a fourth aspect of the present disclosure, a method of manufacturing a member, the method includes providing a base component, a first tubular component that has a tubular shape, that includes a tubular portion including a first end surface, and that is supported by the base component, and a second tubular component that has a tubular shape, that includes a tubular portion including a second end surface, that is made of a material whose coefficient of linear expansion is higher than that of the first tubular component, and that is supported by the base component, wherein one of the tubular portion of the first tubular component or the tubular portion of the second tubular component includes a projection portion that projects from the first end surface or the second end surface, wherein the other of the one of the tubular portion of the first tubular component or the tubular portion of the second tubular component includes a recess portion that is recessed from the first end surface or the second end surface, and that is in contact with the projection portion at at least two positions, and joining the first tubular component and the second tubular component such that a first clearance is formed between the first end surface and the second end surface for allowing relative movement between the first end surface and the second end surface in a direction in which the first end surface and the second end surface face each other, in a case where the base component and the second tubular component relatively expand or contract with respect to the first tubular component due to change in temperature, and a contact state between the projection portion and the recess portion is kept even if the first end surface and the second end surface are relatively moved with respect to each other in the direction in which the first end surface and the second end surface face each other, by one of the projection portion or the recess portion expanding or contracting with respect to another.

Further features of the present disclosure will become apparent from the following description of exemplary embodiments with reference to the attached drawings.

### BRIEF DESCRIPTION OF THE DRAWINGS

FIG. 1 is a perspective view illustrating a composite cylinder member of a first embodiment.

FIG. 2 is a cross-sectional view illustrating the composite cylinder member of the first embodiment.

FIG. 3 is an exploded perspective view illustrating the composite cylinder member of the first embodiment.

FIG. 4 is an enlarged cross-sectional view illustrating a joint portion of the composite cylinder member of the first embodiment.

FIG. 5 is a perspective view illustrating a composite cylinder member of a second embodiment.

FIG. 6 is a cross-sectional view illustrating the composite cylinder member of the second embodiment.

FIG. 7 is an exploded perspective view illustrating the composite cylinder member of the second embodiment.

FIG. 8 is a perspective view illustrating a composite cylinder member of a third embodiment.

FIG. 9 is a cross-sectional view illustrating the composite cylinder member of the third embodiment.

FIG. 10 is an exploded perspective view illustrating the composite cylinder member of the third embodiment.

FIG. 11 is an enlarged cross-sectional view illustrating a joint portion of the composite cylinder member of the third embodiment.

FIG. 12 is a perspective view illustrating a composite cylinder member of a first example.

FIG. 13 is a cross-sectional view illustrating the composite cylinder member of the first example.

FIG. 14 is an exploded perspective view illustrating the composite cylinder member of the first example.

FIG. 15 is a perspective view illustrating a composite cylinder member of a comparative example.

FIG. 16 is a cross-sectional view illustrating the composite cylinder member of the comparative example.

FIG. 17 is an exploded perspective view illustrating the composite cylinder member of the comparative example.

FIG. 18 is a perspective view illustrating a composite cylinder member of a fourth example.

FIG. 19 is a cross-sectional view illustrating the composite cylinder member of the fourth example.

FIG. 20 is an exploded perspective view illustrating the composite cylinder member of the fourth example.

FIG. 21 is a perspective view illustrating a composite cylinder member of a fifth example.

FIG. 22 is a cross-sectional view illustrating the composite cylinder member of the fifth example.

FIG. 23 is an exploded perspective view illustrating the composite cylinder member of the fifth example.

FIG. 24 is a perspective view illustrating a composite cylinder member of a sixth example.

FIG. 25 is a cross-sectional view illustrating the composite cylinder member of the sixth example.

FIG. 26 is an exploded perspective view illustrating the composite cylinder member of the sixth example.

FIG. 27 is a perspective view illustrating a composite cylinder member of a seventh example.

FIG. 28 is a cross-sectional view illustrating the composite cylinder member of the seventh example.

FIG. 29 is an exploded perspective view illustrating the composite cylinder member of the seventh example.

FIG. 30 is a front view illustrating a composite cylinder member of a fourth embodiment.

FIG. 31 is a perspective view illustrating the composite cylinder member of the fourth embodiment.

FIG. 32A is a front view illustrating a composite cylinder member of a fifth embodiment.

FIG. 32B is a cross-sectional view taken along a line indicated by arrows A-A in FIG. 32A.

FIG. 33A is a front view illustrating a composite cylinder member of a sixth embodiment.

FIG. 33B is a cross-sectional view taken along a line indicated by arrows B-B in FIG. 33A.

FIG. 34A is a front view illustrating a composite cylinder member of an eighth example.

FIG. 34B is a cross-sectional view taken along a line indicated by arrows C-C in FIG. 34A.

FIG. 35 is a perspective view illustrating one example of a braiding apparatus.

FIG. 36A is a schematic diagram illustrating a projection portion and a recess portion of the composite cylinder member of the fourth embodiment.

FIG. 36B is a schematic diagram illustrating a projection portion and a recess portion of a composite cylinder member of a first modification.

FIG. 36C is a schematic diagram illustrating a projection portion and a recess portion of a composite cylinder member of a second modification.

FIG. 36D is a schematic diagram illustrating a projection portion and a recess portion of a composite cylinder member of a third modification.

FIG. 36E is a schematic diagram illustrating a projection portion and a recess portion of a composite cylinder member of a fourth modification.

FIG. 36F is a schematic diagram illustrating a projection portion and a recess portion of a composite cylinder member of a fifth modification.

FIG. 36G is a schematic diagram illustrating a projection portion and a recess portion of a composite cylinder member of a sixth modification.

FIG. 36H is a schematic diagram illustrating a projection portion and a recess portion of a composite cylinder member of a seventh modification.

### DESCRIPTION OF THE EMBODIMENTS

In an interchangeable lens or the like, a component that is slid for zooming or focusing is required to have high roundness. However, since the joined member as described in Japanese Patent Application Publication No. 2019-194018 is formed by joining the cylindrical component, which contains the continuous carbon fiber and the thermoplastic resin, and the cylindrical molded resin product with each other, the two components may have different coefficients of linear expansion. In such a joined member in which two components having different coefficients of linear expansion are joined with each other, if the environmental temperature changes and one of the components having a higher coefficient of linear expansion expands or contracts, the component is restricted by the other component having a lower coefficient of linear expansion and deforms unevenly, which deteriorates the roundness. In addition, there is a case where even if the two components have the same coefficient of linear expansion in the joined member, one of the components has an insufficient roundness. In this case, even if the other component has a sufficient roundness, the other component deforms when the two components are joined with each other. As a result, the roundness of the joined member will deteriorate. Note that even if the joined member has another cylindrical shape whose cross section is not circular but polygonal or the like, the shape of the joined member will be deteriorated similarly by the difference in the coefficient of expansion or in the accuracy.

The present disclosure provides a member that can achieve good accuracy, a method of manufacturing the member, and an apparatus.

### First Embodiment

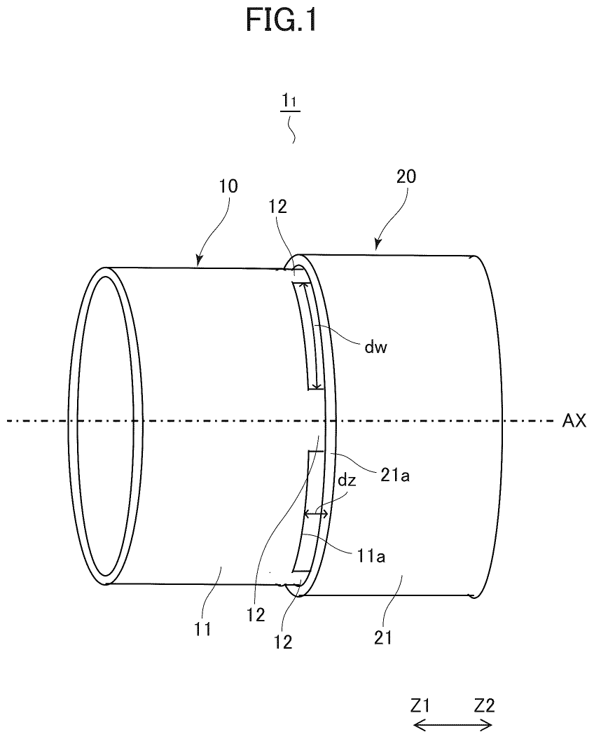

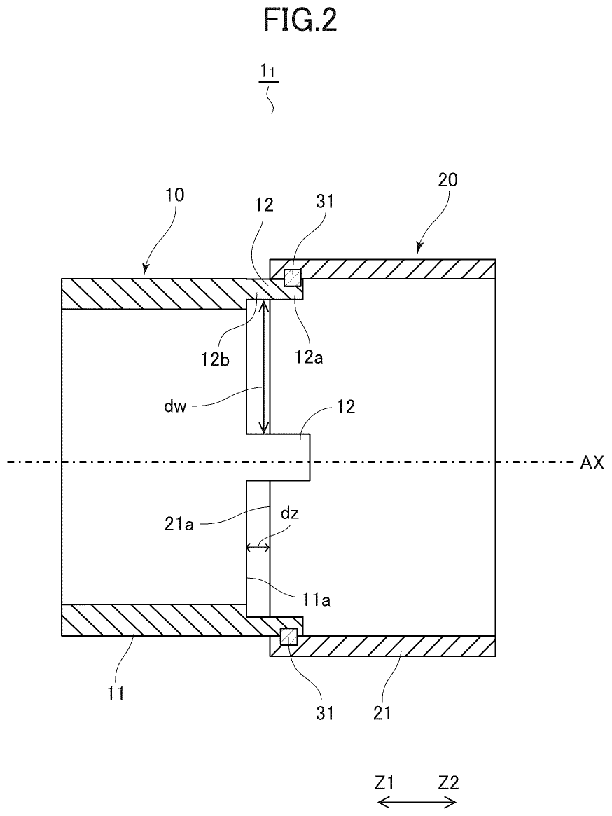

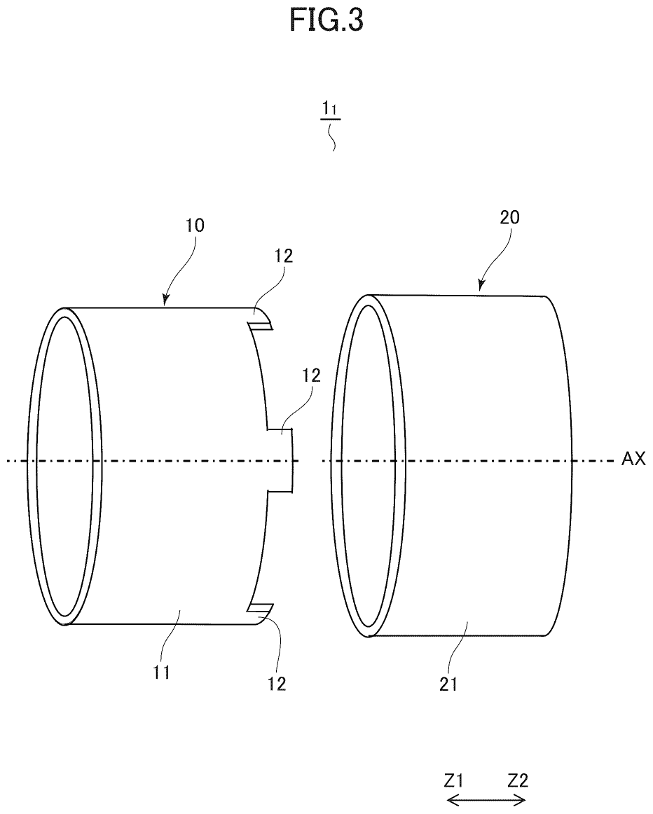

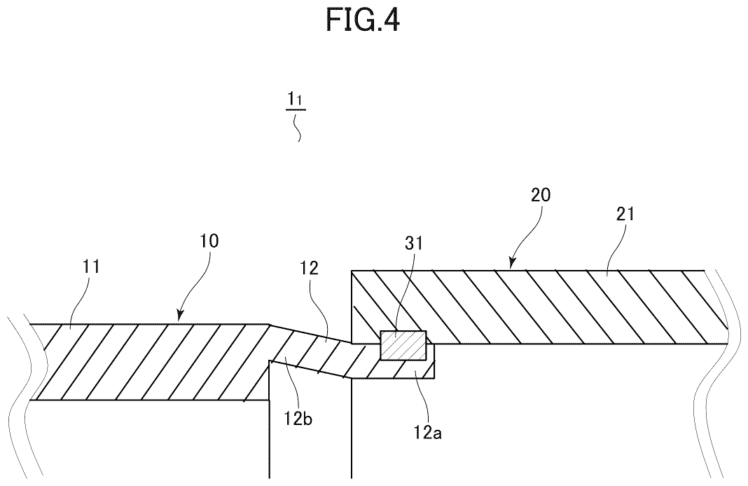

Hereinafter, a first embodiment for embodying the present disclosure will be described with reference to FIGS. 1 to 4. FIG. 1 is a perspective view illustrating a composite cylinder member (which can be referred to simply as a member) that is one example of a joined member (which can be referred to simply as a member) of the first embodiment. FIG. 2 is a cross-sectional view illustrating the composite cylinder member of the first embodiment. FIG. 3 is an exploded perspective view illustrating the composite cylinder member of the first embodiment. FIG. 4 is an enlarged cross-sectional view illustrating a joint portion of the composite cylinder member of the first embodiment. Note that the exploded perspective view of FIG. 3 illustrates a state before a first tubular component 10 and a second tubular component 20, which will be described in detail below, are joined with each other. In addition, since the present embodiment described below is one example, a detailed configuration and the like may be modified as appropriate by a person skilled in the art, without departing from the spirit of the present disclosure. In addition, since a numerical value described in the present embodiment is a value for reference, the present disclosure is not limited by the numerical value.

As illustrated in FIGS. 1, 2, and 3, a composite cylinder member 11 that serves as the joined member includes the first tubular component 10 and the second tubular component 20, which are coaxially disposed on a central axis AX and made of the same material. The first tubular component 10 and the second tubular component 20 are joined with each other in a joint portion 31, via adhesive or the like. Note that in the joint portion 31, the first tubular component 10 and the second tubular component 20 may be joined with each other by using welding or thermal welding if the materials of the first tubular component 10 and the second tubular component 20 are suitable for the welding or thermal welding.

The second tubular component 20 includes a tubular portion 21 that is a cylindrical main body. On the other hand, the first tubular component 10 includes a tubular portion 11 that is a cylindrical main body, and a plurality of projecting portions 12. The plurality of projecting portions 12 are formed so as to project from an end surface 11a of the tubular portion 11 toward one direction (i.e., a Z2 direction) of the axial direction. Each of the projecting portions 12 projects so as to form a so-called tab shape. In addition, each of the tubular portion 11 of the first tubular component 10 and the tubular portion 21 of the second tubular component 20 is formed like a cylinder formed around the central axis AX, and the tubular portion 11 and the tubular portion 21 are coaxially disposed in a state where the tubular portion 11 and the tubular portion 21 are joined with each other.

In addition, the plurality of projecting portions 12 of the first tubular component 10 are disposed such that a clearance dw is formed between projecting portions 12 adjacent to each other in the circumferential direction. For example, in the first embodiment, the projecting portions 12 are spaced evenly from each other in the circumferential direction, and formed at four positions. In other words, the first tubular component 10 is formed such that the plurality of projecting portions 12 are formed (forming process). The projecting portions 12 project from one end (i.e., the end surface 11a) of the tubular portion 11 in the axial direction, and are formed such that the clearance dw is formed between projecting portions 12 adjacent to each other in the circumferential direction. Each of the projecting portions 12 has a thickness slightly smaller than that of the tubular portion 11, and has a so-called tab shape. In addition, each of the projecting portions 12 includes a distal end portion 12a and a base portion 12b. The base portion 12b is formed on the base side (i.e., on the tubular portion 11 side) with respect to the distal end portion 12a. As illustrated in FIG. 2, the distal end portion 12a of each of the projecting portions 12 is inserted and fit into the inner circumference side of the second tubular component 20 such that the distal end portion 12a overlaps with the tubular portion 21 of the second tubular component 20 when viewed in the radial direction. In addition, the joint portion 31 is disposed on the outer circumference of the distal end portion 12a for joining the outer circumference of the distal end portion 12a and the inner circumference of the tubular portion 21. That is, the distal end portion 12a is joined with the second tubular component 20, so that the first tubular component 10 and the second tubular component 20 are joined with each other (joining process).

The base portion 12b is disposed not to overlap with the tubular portion 21 of the second tubular component 20 in the axial direction when viewed in the radial direction. That is, the first tubular component 10 and the second tubular component 20 are disposed such that the end surface 11a of the tubular portion 11 of the first tubular component 10 in an axial direction (i.e., the Z2 direction) and an end surface 21a of the tubular portion 21 of the second tubular component 20 in an axial direction (i.e., a Z1 direction) are separated from each other, with a clearance dz being formed between the end surfaces 11a and 21a in the axial direction. Thus, the base portion 12b of the projecting portion 12 is not in contact with the tubular portion 21 of the second tubular component 20 (that is, the base portion 12b is separated from the tubular portion 21). That is, the outer circumference side of the base portion 12b is not restricted by the tubular portion 21.

As described above, in the composite cylinder member 11 of the first embodiment, the first tubular component 10 and the second tubular component 20 are joined with each other via the plurality of projecting portions 12. Thus, if the first tubular component 10 has a high roundness (with high accuracy) and the second tubular component 20 has a low (insufficient) roundness, the base portion 12b of the projecting portion 12, which is not in contact with the second tubular component 20, deforms as illustrated in FIG. 4. In this manner, the deformation of the tubular portion 11 of the first tubular component 10 can be reduced. That is, the deterioration of roundness of the first tubular component 10 caused by the second tubular component 20 can be reduced.

The joining force between the first tubular component 10 and the second tubular component 20 can be increased as the number of projecting portions 12 or the joint portions 31 increases, so that the strength of the composite cylinder member 11 can be increased. In contrast, the deformation of the tubular portion 11 of the first tubular component 10 can be reduced more as the number of projecting portions 12 or the joint portions 31 decreases. In addition, the joining force between the first tubular component 10 and the second tubular component 20 can be increased as the length of the projecting portion 12 in the circumferential direction increases (that is, as the clearance dw decreases), so that the strength of the composite cylinder member 11 can be increased. In contrast, the deformation of the tubular portion 11 of the first tubular component 10 can be reduced more as the length of the projecting portion 12 in the circumferential direction decreases (that is, as the clearance dw increases). In addition, the joining force between the first tubular component 10 and the second tubular component 20 can be increased as the clearance dz between the end surface 11a of the tubular portion 11 of the first tubular component 10 and the end surface 21a of the tubular portion 21 of the second tubular component 20 decreases, so that the strength of the composite cylinder member 11 can be increased. In contrast, the deformation of the tubular portion 11 of the first tubular component 10 can be reduced more as the clearance dz increases.

In the first embodiment, each of the tubular portion 11 of the first tubular component 10 and the tubular portion 21 of the second tubular component 20 has a cylindrical shape, as one example. However, the cross section of each of the tubular portion 11 and the tubular portion 21 may have an elliptical shape or a polygonal shape (such as a triangular shape, a rectangular shape, a pentagonal shape, or a hexagonal shape). In another case, each of the tubular portion 11 of the first tubular component 10 and the tubular portion 21 of the second tubular component 20 may have a conical shape whose diameter (or slope of the outer circumferential surface) changes in the axial direction.

In the first embodiment, the description has been made for the case where the thickness of the projecting portion 12 is smaller than that of the tubular portion 11 of the first tubular component 10. However, the projecting portion 12 may have a thickness equal to or larger than that of the tubular portion 11 of the first tubular component 10. However, the deformation of the tubular portion 11 of the first tubular component 10 can be reduced more as the thickness of the projecting portion 12 decreases. In contrast, the joining force between the first tubular component 10 and the second tubular component 20 can be increased as the thickness of the projecting portion 12 increases, so that the strength of the composite cylinder member 11 can be increased.

In addition, the coefficient of linear expansion of the first tubular component 10 and the coefficient of linear expansion of the second tubular component 20 may be different from each other. In a case where the first tubular component 10 and the second tubular component 20 are made of metals, one of the first tubular component 10 and the second tubular component 20 may be made of steel and the other may be made of a copper alloy, or one of the first tubular component 10 and the second tubular component 20 may be made of stainless steel and the other may be made of aluminum. In a case where the first tubular component 10 and the second tubular component 20 are made of thermoplastic resins, one of the first tubular component 10 and the second tubular component 20 may be made of polycarbonate and the other may be made of polystyrene, or one of the first tubular component 10 and the second tubular component 20 may be made of PET and the other may be made of ABS. Even in a case where the first tubular component 10 and the second tubular component 20 are made of an identical thermoplastic resin, the coefficient of linear expansion of the first tubular component 10 and the coefficient of linear expansion of the second tubular component 20 may be made different from each other by making the amount of filler of the thermoplastic resin of the first tubular component 10 and the amount of filler of the thermoplastic resin of the second tubular component 20, different from each other. For example, the first tubular component 10 may be made of a polycarbonate that contains no glass filler, and the second tubular component 20 may be made of a polycarbonate that contains 30% of glass filler.

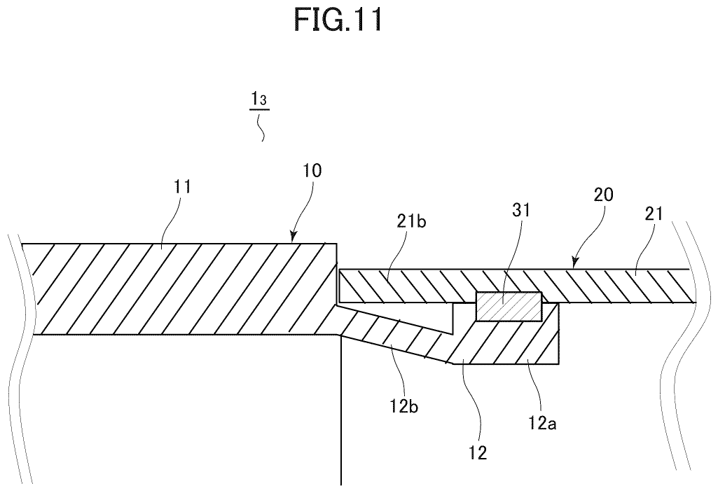

If the composite cylinder member 11, in which the first tubular component 10 and the second tubular component 20 having different coefficients of linear expansion are joined with each other, is exposed, for example, to a high-temperature environment, the amount of expansion differs between the first tubular component 10 and the second tubular component 20. However, since the base portion 12b of the projecting portion 12 deforms (see FIG. 4 and below-described FIG. 11), the deterioration of the roundness of the composite cylinder member 11 can be reduced. Similarly, even when the composite cylinder member 11 is exposed to a low-temperature environment, the same effect can be produced.

In addition, a material of the composite cylinder member 11 may be a carbon-fiber reinforced thermoplastic resin (CFRTP). The CFRTP may contain short-fiber carbon, or may contain long fiber or continuous fiber. As the material of the continuous carbon fiber, a prepreg sheet may be used. In the prepreg sheet, the fiber may be parallel with the axial direction or the circumferential direction, or one braid may be put on another and the braids may have angles with respect to the axial direction. For example, the first tubular component 10, which has a complicated shape like the projecting portions 12, may be made of a thermoplastic resin that contains short-fiber carbon that is a material used for injection molding. In addition, the second tubular component 20, which has a shape simpler than that of the first tubular component 10, may be made of a thermoplastic resin in which a prepreg sheet, which contains continuous carbon fiber, is braided. Since the CFRTP is a high-strength material, the weight of the composite tubular component 11 can be reduced more. The thermoplastic resin that contains continuous carbon fiber has a coefficient of linear expansion of about 0/° C., and the resin that contains the short-fiber carbon has a coefficient of linear expansion higher than that of the resin that contains the continuous carbon fiber. However, if the structure of the composite cylinder member 11 is used, the deterioration of the roundness can be reduced, as described above, in the high-temperature environment or the low-temperature environment.

If the main component of the material of the first tubular component 10 and the main component of the material of the second tubular component 20 are a thermoplastic resin made of an identical material, the first tubular component 10 and the second tubular component 20 can be joined with each other by using thermal welding. In this case, since the carbon fiber has a high thermal conductivity, heat and pressure are applied from a CFRTP side. As a result, the heat is transmitted to the other tubular component, and the thermoplastic resin of the first tubular component 10 and the thermoplastic resin of the second tubular component 20 melt together. In this manner, the first tubular component 10 and the second tubular component 20 can be joined with each other. If the size of each of the joining area of the first tubular component 10 and the joining area of the second tubular component 20 is constant, the joining force obtained by using the thermal welding can be made stronger than the joining force obtained by using adhesive. In particular, the main component of the material of each of the first tubular component 10 and the second tubular component 20 may be polycarbonate. Since polycarbonate is a thermoplastic resin and melted by applying heat, the thermal welding can be performed on the polycarbonate. Furthermore, in a case where the composite cylinder member 11 is used in a lens barrel, the resin outgas is less produced. Since the resin outgas causes fogging of the lens in the thermal welding of polycarbonate, the use of polycarbonate is advantageous.

As described above, the first tubular component 10 and the second tubular component 20 may be made of any material, such as metal, thermosetting resin, or thermoplastic resin. That is, the first tubular component 10 and the second tubular component 20 may be made of an identical material, or may be made of different materials. In the present embodiment, however, since the first tubular component 10 is a component in which the plurality of projecting portions 12 and the tubular portion 11 are formed integrally with each other, it is preferable that the first tubular component 10 be made of resin or the like. In addition, since the second tubular component 20 has a simple cylindrical shape, the second tubular component 20 may be made of a carbon-fiber reinforced thermoplastic resin (CFRTP). If the first tubular component 10 and the second tubular component 20 are made of an identical resin material, or of resins whose main components are an identical material (e.g., polycarbonate), the first tubular component 10 and the second tubular component 20 can be joined with each other in the joint portion 31, by using thermal welding.

Note that the composite cylinder member 11 of the present embodiment can be used in a lens barrel or hood of an optical apparatus, such as an interchangeable lens of a single-lens reflex camera. In addition to this, the composite cylinder member 11 can be used, for example, in an exterior component of a robot arm. That is, the composite cylinder member 11 may be used in any apparatus. In addition to the composite cylinder member of the first embodiment, any of the composite cylinder members described below in the second to the sixth embodiments or the first to the eighth examples may also be used in any apparatus.

For example, in a case where the composite cylinder member 11 is used as a lens barrel, an interchangeable lens (i.e., an optical apparatus that serves as an apparatus) is constituted by the lens barrel (i.e., a member) and a lens (i.e., an optical element that serves as an element) that is enclosed by at least any one of the first tubular component 10 and the second tubular component 20. In a case where the interchangeable lens is configured as described above, a component formed like an attachment portion for a tripod seat may be attached to or formed integrally with at least one of the first tubular component 10 and the second tubular component 20. That is, a component having any shape may be attached to the tubular portion.

In addition, in a case where the composite cylinder member 11 is used as an exterior component of a robot arm, a robot (i.e., a mechanical apparatus that serves as an apparatus) includes the exterior component (i.e., a member) and at least one component (i.e., an electrical or mechanical element that serves as an element), such as wiring, a motor, a gear, and a link, that is enclosed by at least any one of the first tubular component 10 and the second tubular component 20.

Thus, the composite cylinder member 11 may be used in any apparatus as long as the apparatus is constituted by the composite cylinder member (i.e., a member) 11 and at least one element that is enclosed by at least any one of the first tubular component 10 and the second tubular component 20.

### Second Embodiment

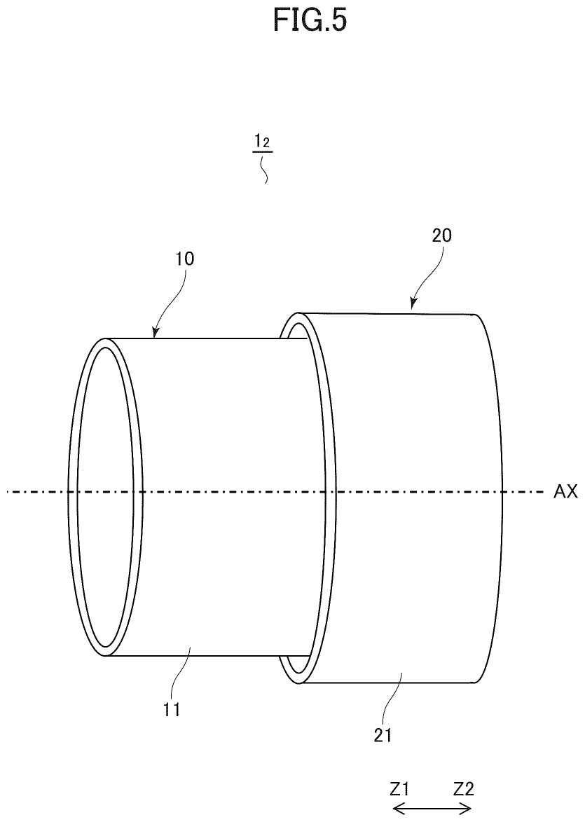

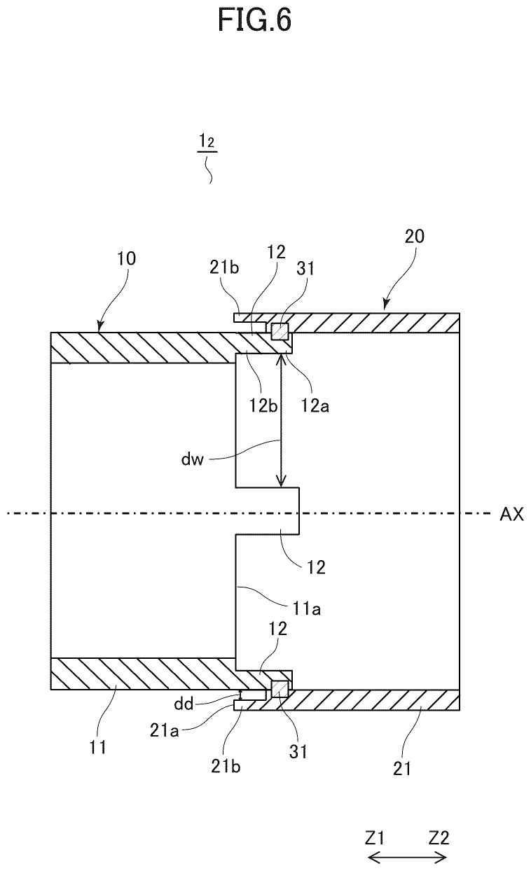

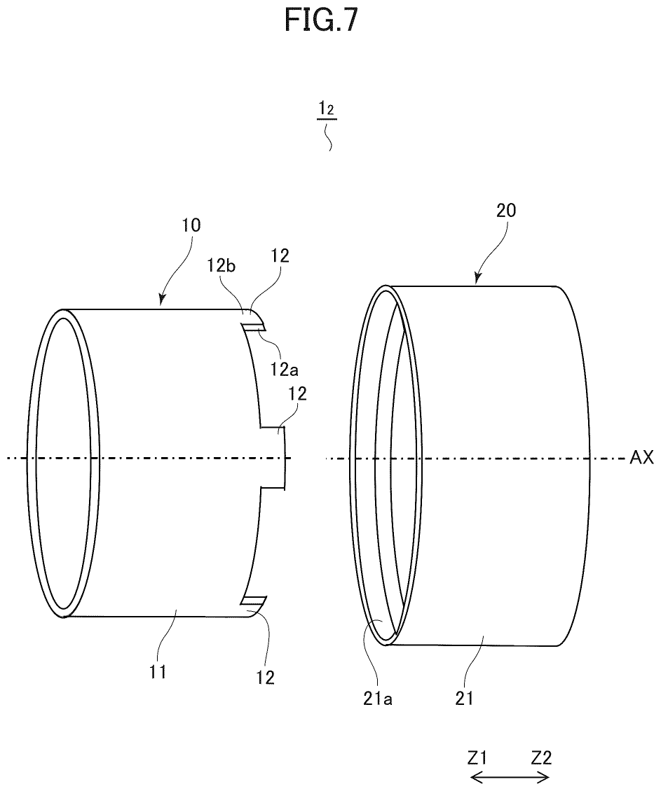

Next, a second embodiment will be described with reference to FIGS. 5 to 7. In the second embodiment, part of the first embodiment is changed. FIG. 5 is a perspective view illustrating a composite cylinder member of the second embodiment. FIG. 6 is a cross-sectional view illustrating the composite cylinder member of the second embodiment. FIG. 7 is an exploded perspective view illustrating the composite cylinder member of the second embodiment. Note that in the description of the second embodiment, a component identical to a component of the above-described first embodiment is given an identical symbol, and the description thereof will be omitted.

As illustrated in FIGS. 5, 6, and 7, unlike in the composite cylinder member 11 of the first embodiment, in a composite cylinder member 12 of the second embodiment that serves as a joined member, the thickness of the distal end portion of the tubular portion 21 of the second tubular component 20 in the axial direction (i.e., the Z1 direction) is made thinner.

Specifically, as illustrated in FIGS. 5, 6, and 7, in the composite cylinder member 12, the first tubular component 10 and the second tubular component 20 are disposed such that the position of the end surface 11a of the tubular portion 11 of the first tubular component 10 and the position of the end surface 21a of the tubular portion 21 of the second tubular component 20 are equal to each other in the axial direction. In addition, the end portion 21b of the tubular portion 21 of the second tubular component 20 is made thinner such that the inner circumference side of the end portion 21b is recessed toward the outer circumference side of the end portion 21b in a position in which the inner circumference side of the tubular portion 21 overlaps with the base portion 12b of the projecting portion 12 in the axial direction. That is, a clearance dd is formed between the end portion 21b of the tubular portion 21 of the second tubular component 20 and the base portion 12b of the projecting portion 12, and the end portion 21b of the tubular portion 21 and the base portion 12b of the projecting portion 12 are separated from each other in an inner-and-outer diameter direction (i.e., a radial direction), via the clearance dd. Thus, the base portion 12b of the projecting portion 12 is not in contact with the tubular portion 21 of the second tubular component 20 (that is, the base portion 12b is separated from the tubular portion 21). That is, the outer circumference side of the base portion 12b is not restricted by the tubular portion 21.

Even in the composite cylinder member 12 of the second embodiment configured as described above, the first tubular component 10 and the second tubular component 20 are joined with each other via the plurality of projecting portions 12. Thus, if the first tubular component 10 has a high roundness (with high accuracy) and the second tubular component 20 has a low (insufficient) roundness, the base portion 12b of the projecting portion 12, which is not in contact with the second tubular component 20, deforms. In this manner, the deformation of the tubular portion 11 of the first tubular component 10 can be reduced. That is, the deterioration of roundness of the first tubular component 10 caused by the second tubular component 20 can be reduced.

### Third Embodiment

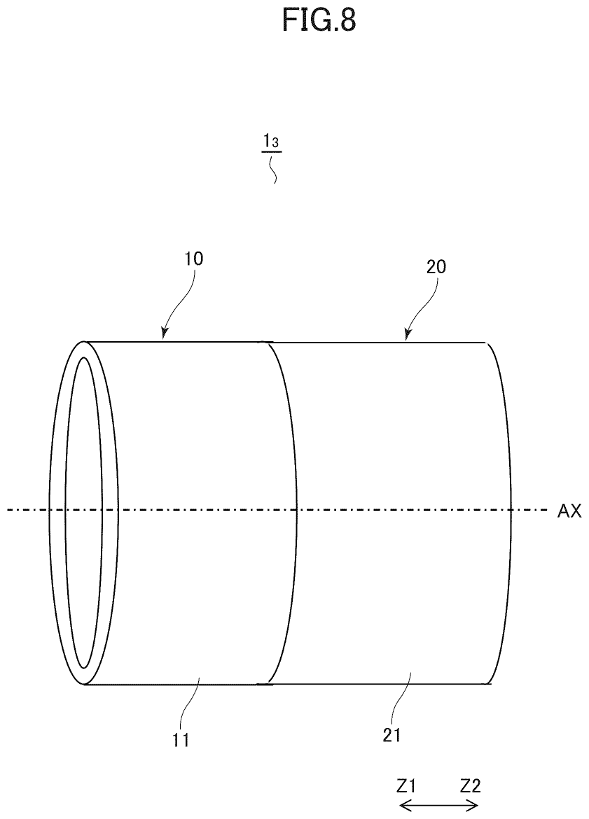

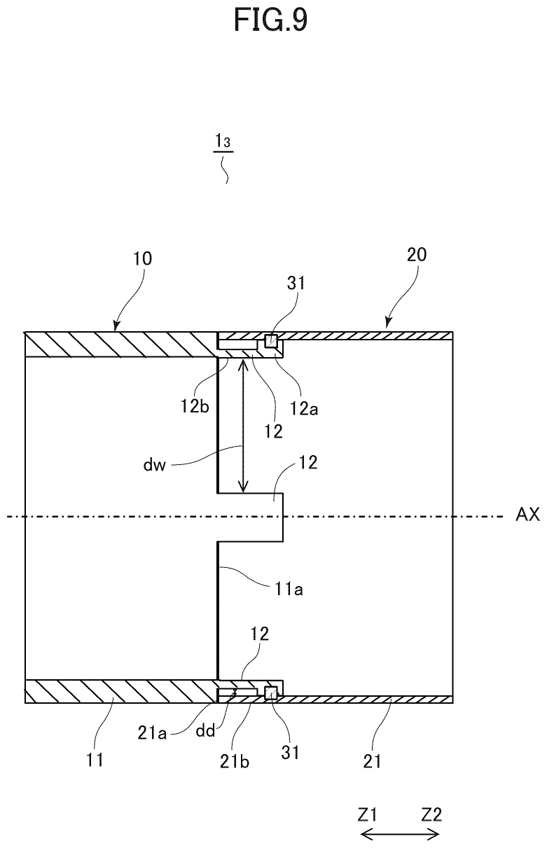

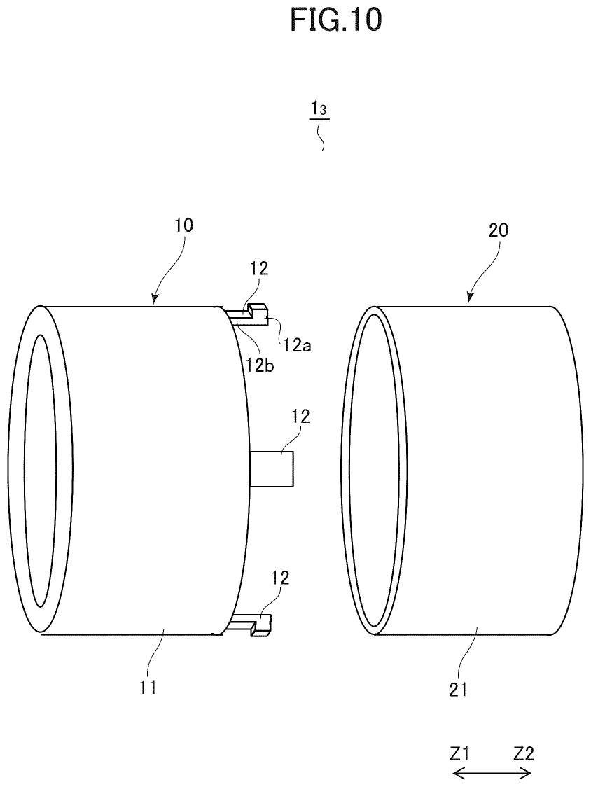

Next, a third embodiment will be described with reference to FIGS. 8 to 11. In the third embodiment, part of the first and second embodiments is changed. FIG. 8 is a perspective view illustrating a composite cylinder member of the third embodiment. FIG. 9 is a cross-sectional view illustrating the composite cylinder member of the third embodiment. FIG. 10 is an exploded perspective view illustrating the composite cylinder member of the third embodiment. FIG. 11 is an enlarged cross-sectional view illustrating a joint portion of the composite cylinder member of the third embodiment. Note that in the description of the third embodiment, a component identical to a component of the above-described first and second embodiments is given an identical symbol, and the description thereof will be omitted.

As illustrated in FIGS. 8, 9, 10, and 11, unlike in the composite cylinder members 11 and 12 of the first and the second embodiments, in a composite cylinder member 13 of the third embodiment that serves as a joined member, the outer diameter of the tubular portion 11 of the first tubular component 10 and the outer diameter of the tubular portion 21 of the second tubular component 20 are made almost equal to each other. In other words, the first tubular component 10 is formed so that the projecting portions 12 enter the inner circumference side of the tubular portion 21 of the second tubular component 20, by making the thickness of the projecting portions 12 of the first tubular component 10, thinner than the thickness of the tubular portion 11.

Specifically, as illustrated in FIGS. 8, 9, and 10, in the composite cylinder member 13, the first tubular component 10 and the second tubular component 20 are disposed such that the position of the end surface 11a of the tubular portion 11 of the first tubular component 10 and the position of the end surface 21a of the tubular portion 21 of the second tubular component 20 are equal to each other in the axial direction when viewed in the radial direction. In addition, the first tubular component 10 and the second tubular component 20 are disposed such that the end surface 21a of the tubular portion 21 of the second tubular component 20 overlaps with the end surface 11a of the tubular portion 11 of the first tubular component 10 in the radial direction, or slightly projects from the end surface 11a of the tubular portion 11 of the first tubular component 10 toward the outer circumference side when viewed in the axial direction. Thus, in the composite cylinder member 13, the connection portion between the first tubular component 10 and the second tubular component 20 is formed so that the first tubular component 10 and the second tubular component 20 are connected with each other, and that the composite cylinder member 13 is formed like a continuous cylinder and has an almost constant outer diameter.

In addition, the projecting portion 12 of the first tubular component 10 is formed such that the thickness of the whole of the projecting portion 12 is smaller than the thickness of the tubular portion 11, and that the thickness of the base portion 12b is smaller than the thickness of the distal end portion 12a. That is, a clearance dd is formed between the tubular portion 21 of the second tubular component 20 and the base portion 12b of the projecting portion 12, in the inner-and-outer diameter direction. Thus, the base portion 12b of the projecting portion 12 is not in contact with the tubular portion 21 of the second tubular component 20. That is, the outer circumference side of the base portion 12b is not restricted by the tubular portion 21.

Even in the composite cylinder member 13 of the third embodiment configured as described above, the first tubular component 10 and the second tubular component 20 are joined with each other via the plurality of projecting portions 12. Thus, if the first tubular component 10 has a high roundness (with high accuracy) and the second tubular component 20 has a low (insufficient) roundness, the base portion 12b of the projecting portion 12, which is not in contact with the second tubular component 20, deforms as illustrated in FIG. 11. In this manner, the deformation of the tubular portion 11 of the first tubular component 10 can be reduced. That is, the deterioration of roundness of the first tubular component 10 caused by the second tubular component 20 can be reduced.

### First Example

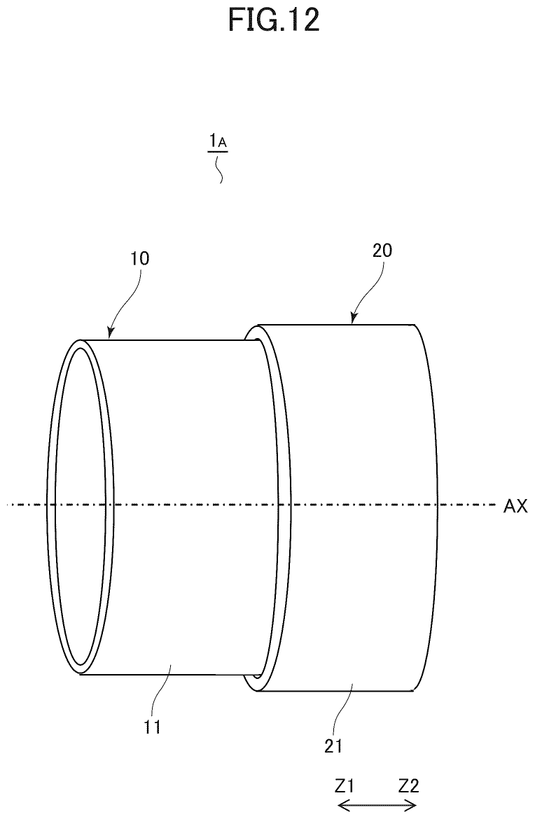

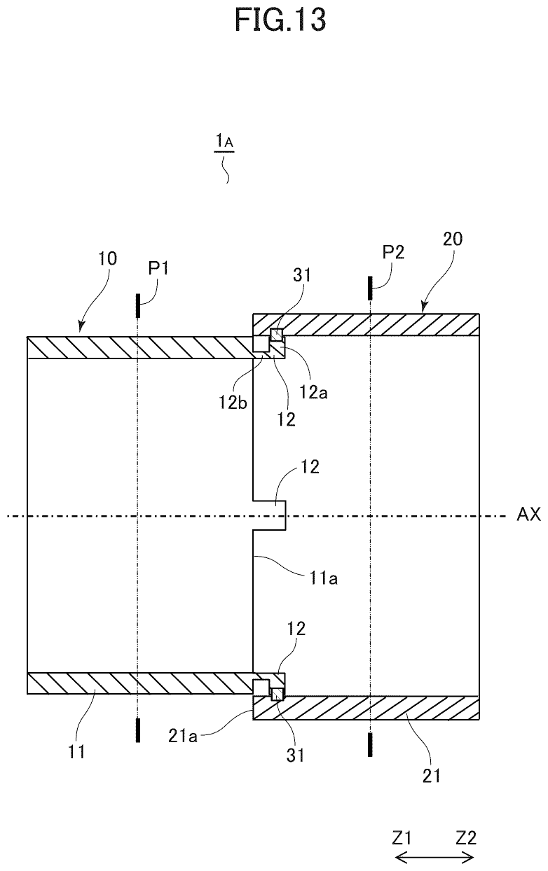

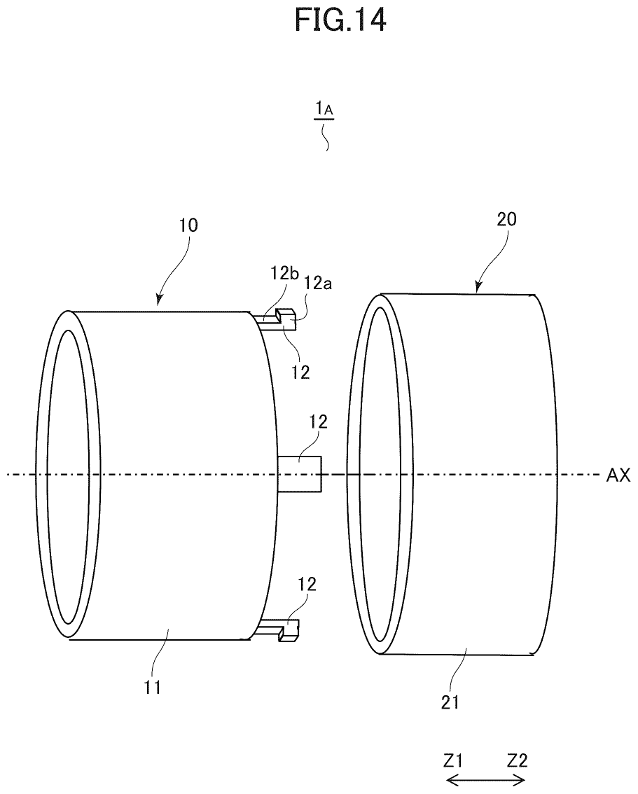

Next, a first example that is one example of the present embodiments will be described with reference to FIGS. 12, 13, and 14. FIG. 12 is a perspective view illustrating a composite cylinder member of the first example. FIG. 13 is a cross-sectional view illustrating the composite cylinder member of the first example. FIG. 14 is an exploded perspective view illustrating the composite cylinder member of the first example. Note that in the description of the first example, a component identical to a component of the above-described first to third embodiments is given an identical symbol, and the description thereof will be omitted.

As illustrated in FIGS. 12, 13, and 14, in a composite cylinder member 1A of the first example, each of the first tubular component 10 and the second tubular component 20 has a cylindrical shape. The material of both of the first tubular component 10 and the second tubular component 20 is SUS304, which is a metal material. The outer diameter (i.e., a diameter) of the tubular portion 11 of the first tubular component 10 was set at 140 mm, the basic thickness of the tubular portion 11 was set at 1.0 mm, and the length of the tubular portion 11 in the axial direction was set at 90 mm. The tubular portion 11 was formed so as to have the projecting portions 12 that project from the end surface 11a on one side of the tubular portion 11 in the axial direction. Each of the projecting portions 12 was shaped like a tab, and the projecting portions 12 were formed at intervals of 90 degrees on a circle (i.e., in the circumferential direction). That is, the projecting portions 12 were formed at four positions. In the projecting portion 12, the length of the projecting portion 12 in the axial direction was set at 20 mm, the width of the projecting portion 12 in the circumferential direction was set at 10 mm, the thickness of the base portion 12b was set at 0.2 mm, and the thickness of the distal end portion 12a was set at 1.0 mm. In addition, the length of the base portion 12b in the axial direction was set at 10 mm, and the length of the distal end portion 12a in the axial direction was set at 10 mm. On the other hand, in the tubular portion 21 of the second tubular component 20, the basic thickness of the tubular portion 21 was set at 1.0 mm, the outer diameter (i.e., a diameter) of the tubular portion 21 was set at 142 mm, and the length of the tubular portion 21 in the axial direction was set at 80 mm.

Before the first tubular component 10 and the second tubular component 20 were joined with each other, the roundness of the tubular portion 11 of the first tubular component 10 other than the projecting portions 12 was 0.03 mm at a center position P1 in the axial direction, and the roundness of the tubular portion 21 of the second tubular component 20 was 1.20 mm at a center position P2 in the axial direction.

The joint portion 31 between the first tubular component 10 and the second tubular component 20 was formed in a position in which the distal end portion 12a of the projecting portion 12 of the first tubular component 10 and the inner circumference of the tubular portion 21 of the second tubular component 20 were in contact with each other. The first tubular component 10 and the second tubular component 20 were joined with each other by injecting adhesive into the clearance between the distal end portion 12a of the projecting portion 12 and the tubular portion 21, from the inner circumference side of the tubular portion 21. After the first tubular component 10 and the second tubular component 20 were joined with each other, the roundness of the first tubular component 10 of the composite cylinder member 1A was measured at the center position P1, and the roundness of the second tubular component 20 of the composite cylinder member 1A was measured at the center position P2. As a result, the roundness of the first tubular component 10 was 0.04 mm, and the roundness of the second tubular component 20 was 1.4.

### COMPARATIVE EXAMPLE

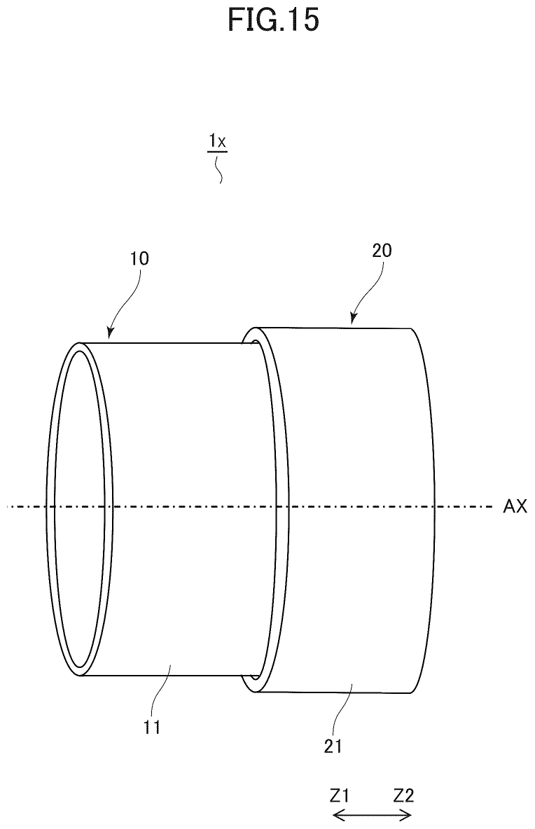

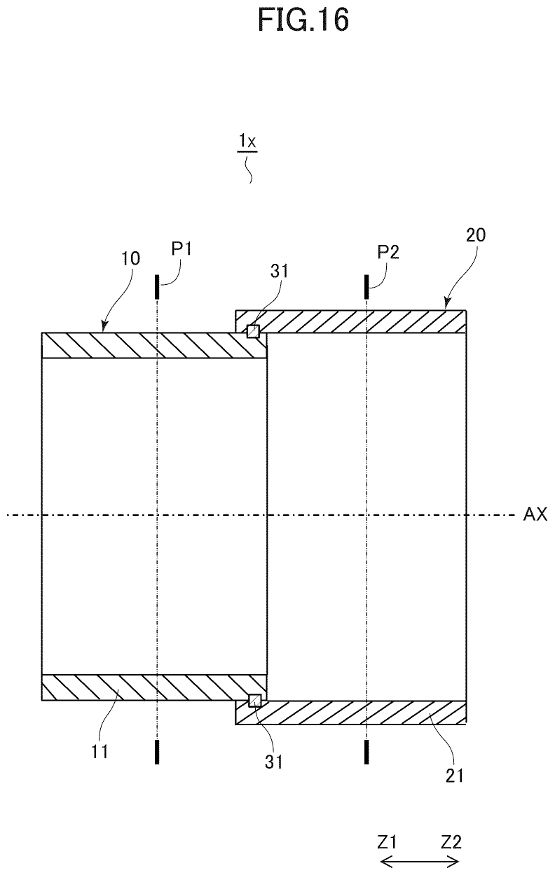

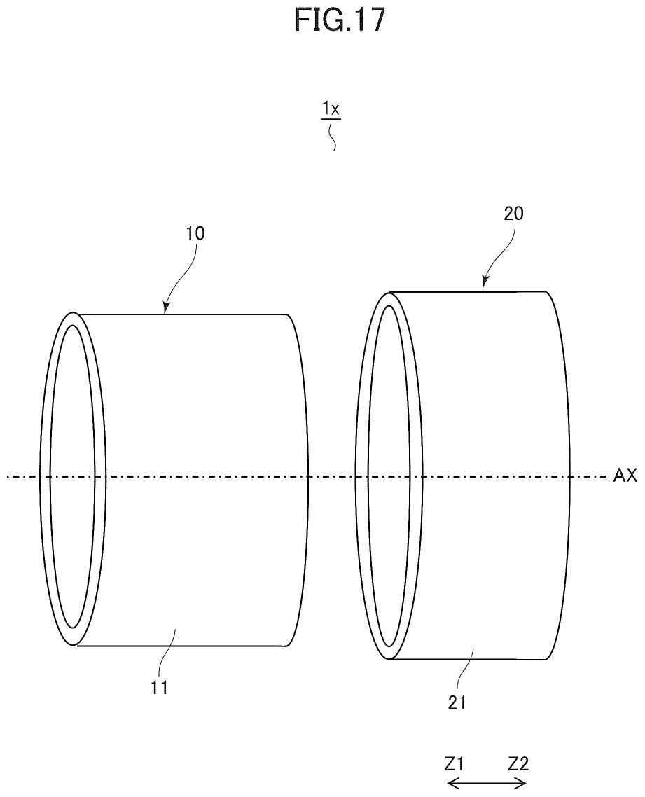

Next, a comparative example for comparison with the present example will be described with reference to FIGS. 15, 16, and 17. FIG. 15 is a perspective view illustrating a composite cylinder member of the comparative example. FIG. 16 is a cross-sectional view illustrating the composite cylinder member of the comparative example. FIG. 17 is an exploded perspective view illustrating the composite cylinder member of the comparative example. Note that also in the description of the comparative example, a component identical to a component of the above-described first to third embodiments and the first example is given an identical symbol, and the description thereof will be omitted.

In a composite cylinder member 1_{X} of the comparative example, the tubular portion 11 of the first tubular component 10 has the same shape and material as those of the tubular portion 11 of the first example, and the tubular portion 21 of the second tubular component 20 has the same shape and material as those of the tubular portion 21 of the first example. That is, in the comparative example, unlike in the above-described first example, the first tubular component 10 does not include the projecting portions 12, and the tubular portion 11 and the tubular portion 21 were directly joined with each other in the joint portion 31. The length of the tubular portion 11 of the first tubular component 10 in the axial direction was set at 110 mm, and the outer diameter and the thickness of the tubular portion 11 were made equal to those of the tubular portion 11 of the first example. The shape of the tubular portion 21 of the second tubular component 20 was made absolutely equal to the shape of the tubular portion 21 of the second tubular component 20 of the first example. Before the first tubular component 10 and the second tubular component 20 were joined with each other, the roundness of the first tubular component 10 and the roundness of the second tubular component 20 were the same as those in the first example.

In the composite cylinder member 1_{X} in which the first tubular component 10 and the second tubular component 20 were joined with each other, the inner circumference of the tubular portion 21 of the second tubular component 20 was fit to the outer circumference of the tubular portion 11 of the first tubular component 10, by 20 mm. In this state, as in the first example, the first tubular component 10 and the second tubular component 20 were joined with each other in four joint portions 31, by injecting adhesive into the clearance formed around the circumference (in the circumferential direction), at intervals of 90 degrees. The area onto which the adhesive was applied is the same as that in the first example.

In the composite cylinder member 1_{X} in which the first tubular component 10 and the second tubular component 20 were joined with each other, the roundness was measured. As a result, the roundness of the first tubular component 10 was 0.9 mm, and the roundness of the second tubular component 20 was 1.5 mm. In comparison with the comparative example, in the first example, since the projecting portions 12, especially the base portions 12b, deform, the deformation of the tubular portion 11 of the first tubular component 10 other than the projecting portions 12 was reduced, and the deterioration of the roundness was reduced.

### Second Example

Next, a second example that is one example of the present embodiments will be described. Note that also in the description of the second example, a component identical to a component of the above-described first to third embodiments and the first example is given an identical symbol, and the description thereof will be omitted.

In a composite cylinder member 1 (not illustrated) of the second example, unlike in the first example, six projecting portions 12 of the first tubular component 10 were disposed, spaced evenly from each other in the circumferential direction. Each of the first tubular component 10 and the second tubular component 20 has a cylindrical shape. The material of both of the first tubular component 10 and the second tubular component 20 is polystyrene, which is a thermoplastic resin. The outer diameter (i.e., a diameter) of the tubular portion 11 of the first tubular component 10 was set at 140 mm, the basic thickness of the tubular portion 11 was set at 1.5 mm, and the length of the tubular portion 11 in the axial direction was set at 80 mm. The tubular portion 11 was formed so as to have the projecting portions 12 that project from the end surface 11a on one side of the tubular portion 11 in the axial direction. Each of the projecting portions 12 was shaped like a tab, and the projecting portions 12 were formed at intervals of 60 degrees on a circle (i.e., in the circumferential direction). That is, the projecting portions 12 were formed at six positions. In the projecting portion 12, the length of the projecting portion 12 in the axial direction was set at 20 mm, the width of the projecting portion 12 in the circumferential direction was set at 10 mm, the thickness of the base portion 12b was set at 0.8 mm, and the thickness of the distal end portion 12a was set at 1.5 mm. In addition, the length of the base portion 12b in the axial direction was set at 10 mm, and the length of the distal end portion 12a in the axial direction was set at 10 mm. On the other hand, in the second tubular component 20, the basic thickness of the tubular portion 21 was set at 1.5 mm, the diameter of the tubular portion 21 was set at 143 mm, and the length of the tubular portion 21 in the axial direction was set at 130 mm.

Before the first tubular component 10 and the second tubular component 20 were joined with each other, the roundness of the tubular portion 11 of the first tubular component 10 other than the projecting portions 12 was 0.02 mm at a center position P1 in the axial direction (that is, at a position separated by 40 mm from an end surface opposite to the joint portion 31 in the axial direction). In addition, the roundness of the tubular portion 21 of the second tubular component 20 was 0.8 mm at a center position P2 in the axial direction (that is, at a position separated by 65 mm from an end surface opposite to the joint portion 31 in the axial direction).

The joint portion 31 between the first tubular component 10 and the second tubular component 20 was formed in a position in which the distal end portion 12a of the projecting portion 12 of the first tubular component 10 and the inner circumference of the second tubular component 20 were in contact with each other in a state where the whole of the projecting portions 12 was inserted into the inner circumference side of the tubular portion 21 of the second tubular component 20. The first tubular component 10 and the second tubular component 20 were joined with each other by injecting adhesive into the clearance between the distal end portion 12a of the projecting portion 12 and the tubular portion 21 of the second tubular component 20. After the first tubular component 10 and the second tubular component 20 were joined with each other, the roundness of each of the first tubular component 10 and the second tubular component 20 of the composite cylinder member 1 was measured. As a result, the roundness of the first tubular component 10 was 0.03 mm, and the roundness of the second tubular component 20 was 0.9 mm. In comparison with the above-described comparative example, in the second example, since the projecting portions 12, especially the base portions 12b, deform, the deformation of the tubular portion 11 of the first tubular component 10 other than the projecting portions 12 was reduced, and the deterioration of the roundness was reduced.

### Third Example

Next, a third example that is one example of the present embodiments will be described. Note that also in the description of the third example, a component identical to a component of the above-described first to third embodiments and the first and second examples is given an identical symbol, and the description thereof will be omitted.

In a composite cylinder member 1 (not illustrated) of the third example, unlike in the second example, the thickness of the distal end portion 12a of the projecting portion 12 and the thickness of the base portion 12b of the projecting portions 12 were made equal to each other, and were set at 1.5 mm. That is, no clearance was formed between the outer circumference side of the projecting portion 12 and the tubular portion 21 of the second tubular component 20. In addition, the area onto which the adhesive was applied in the joint portion 31 is the same as that in the second example.

Before the first tubular component 10 and the second tubular component 20 were joined with each other, the roundness of the tubular portion 11 of the first tubular component 10 other than the projecting portions 12 was 0.02 mm at a center position P1 in the axial direction (that is, at a position separated by 40 mm from an end surface opposite to the joint portion 31 in the axial direction). In addition, the roundness of the tubular portion 21 of the second tubular component 20 was 0.8 mm at a center position P2 in the axial direction (that is, at a position separated by 65 mm from an end surface opposite to the joint portion 31 in the axial direction).

The joint portion 31 between the first tubular component 10 and the second tubular component 20 was formed in a position in which the projecting portion 12 of the first tubular component 10 and the inner circumference of the second tubular component 20 were in contact with each other in a state where the whole of the projecting portions 12 was inserted into the inner circumference side of the tubular portion 21 of the second tubular component 20. The first tubular component 10 and the second tubular component 20 were joined with each other by injecting adhesive into the clearance between the distal end portion 12a of the projecting portion 12 and the tubular portion 21 of the second tubular component 20. After the first tubular component 10 and the second tubular component 20 were joined with each other, the roundness of each of the first tubular component 10 and the second tubular component 20 of the composite cylinder member 1 was measured. As a result, the roundness of the first tubular component 10 was 0.85 mm, and the roundness of the second tubular component 20 was 1.1 mm. Thus, in comparison with the above-described second example, in the third example, the roundness deteriorated because the base portion 12b of the projecting portion 12 is restricted by the tubular portion 21 and hardly deforms. However, in comparison with the above-described comparative example, in the third example, since the projecting portions 12 deform, the deformation of the tubular portion 11 of the first tubular component 10 other than the projecting portions 12 was reduced, and the deterioration of the roundness was reduced.

### Fourth Example

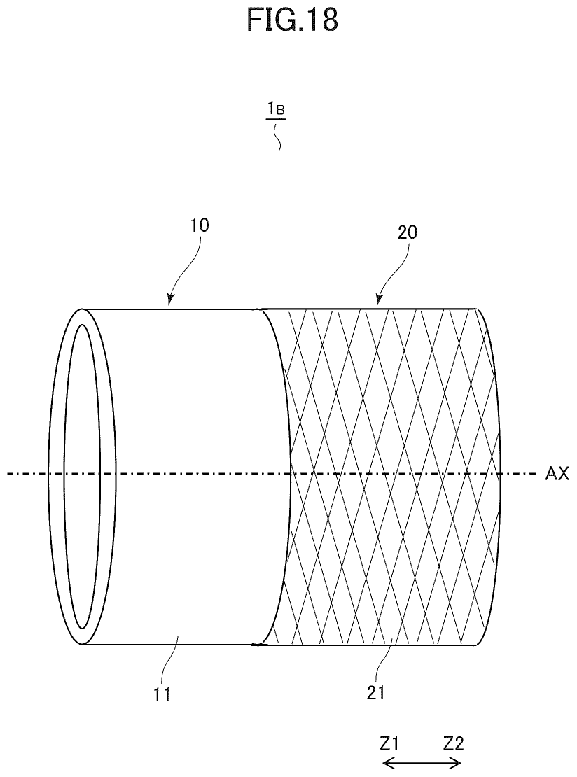

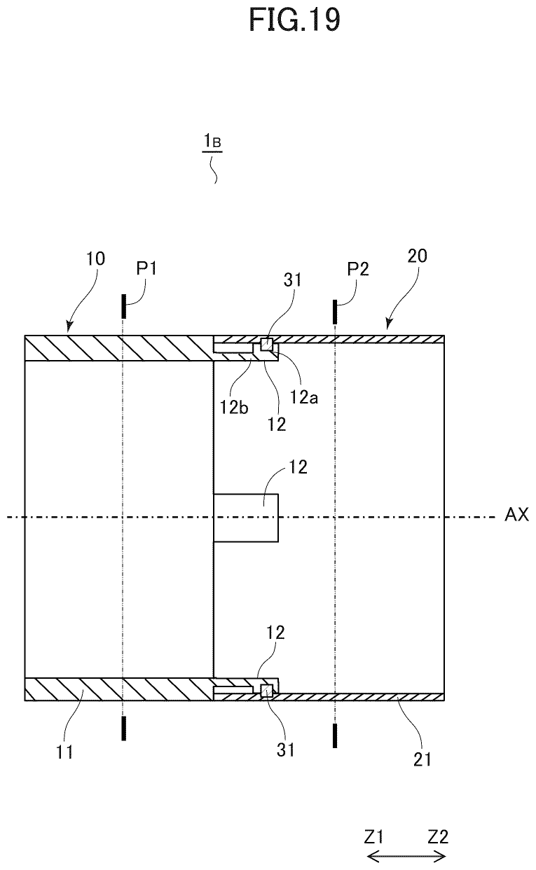

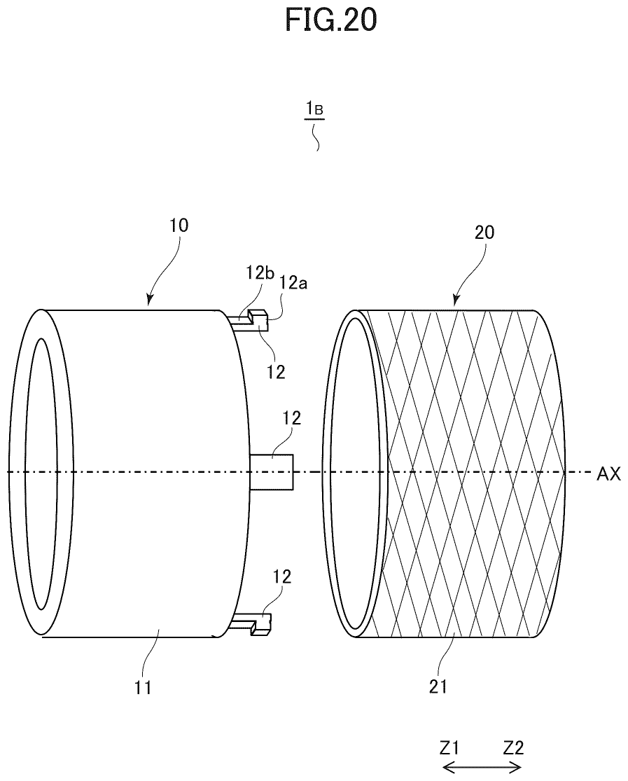

Next, a fourth example that is one example of the present embodiments will be described with reference to FIGS. 18, 19, and 20. FIG. 18 is a perspective view illustrating a composite cylinder member of the fourth example. FIG. 19 is a cross-sectional view illustrating the composite cylinder member of the fourth example. FIG. 20 is an exploded perspective view illustrating the composite cylinder member of the fourth example. Note that also in the description of the fourth example, a component identical to a component of the above-described first to third embodiments and the first to the third examples is given an identical symbol, and the description thereof will be omitted.

As illustrated in FIGS. 18, 19, and 20, also in a composite cylinder member 1_{B} of the fourth example, each of the first tubular component 10 and the second tubular component 20 has a cylindrical shape. The material of the first tubular component 10 is a polycarbonate containing 30% of short-fiber carbon and having a coefficient of linear expansion of 2.2×10⁻⁵/C. The outer diameter (i.e., a diameter) of the tubular portion 11 of the first tubular component 10 was set at 140 mm, the basic thickness of the tubular portion 11 was set at 1.5 mm, and the length of the tubular portion 11 in the axial direction was set at 80 mm. The tubular portion 11 was formed so as to have the projecting portions 12 that project from the end surface 11a on one side of the tubular portion 11 in the axial direction. Each of the projecting portions 12 was shaped like a tab, and the projecting portions 12 were formed at intervals of 90 degrees on a circle (i.e., in the circumferential direction). That is, the projecting portions 12 were formed at four positions. In the projecting portion 12, the length of the projecting portion 12 in the axial direction was set at 20 mm, the width of the projecting portion 12 in the circumferential direction was set at 10 mm, the thickness of the base portion 12b was set at 0.8 mm, and the thickness of the distal end portion 12a was set at 1.5 mm.

In the tubular portion 21 of the second tubular component 20, a prepreg sheet containing 50% of continuous carbon fiber and having a coefficient of linear expansion of about 0/C was used as a material. The main component of the prepreg sheet is polycarbonate. The width of the prepreg sheet (i.e., the width of the tubular portion 21) was set at 10 mm, and the angle of the prepreg sheet with respect to the axial direction of the cylinder was set at 70 degrees. The braid has a two-layer structure. The basic thickness of the braid was set at 0.47 mm, the diameter of the braid was set at 140 mm, and the length of the braid in the axial direction was set at 90 mm.

Before the first tubular component 10 and the second tubular component 20 were joined with each other, the roundness of the tubular portion 11 of the first tubular component 10 other than the projecting portions 12 was 0.03 mm at the center position P1 in the axial direction. In addition, the roundness of the tubular portion 21 of the second tubular component 20 was 0.04 mm at the center position P2 in the axial direction.

The joint portion 31 between the first tubular component 10 and the second tubular component 20 was formed in a position in which the distal end portion 12a of the projecting portion 12 of the first tubular component 10 and the inner circumference of the second tubular component 20 were in contact with each other in a state where the whole of the projecting portions 12 was inserted into the inner circumference side of the tubular portion 21 of the second tubular component 20. The first tubular component 10 and the second tubular component 20 were joined with each other by injecting adhesive into the clearance between the distal end portion 12a of the projecting portion 12 and the tubular portion 21 of the second tubular component 20. After the first tubular component 10 and the second tubular component 20 were joined with each other, the roundness of each of the first tubular component 10 and the second tubular component 20 of the composite cylinder member 1_{B} was measured. As a result, the roundness of the first tubular component 10 was 0.04 mm, and the roundness of the second tubular component 20 was 0.05 mm. In addition, in a state where the composite cylinder member 1_{B} in which the first tubular component 10 and the second tubular component 20 were joined with each other was exposed to a high-temperature environment, the roundness of the first tubular component 10 was 0.04 mm, and the roundness of the second tubular component 20 was 0.05 mm. In addition, in a state where the composite cylinder member 1_{B} was exposed to a low-temperature environment, the roundness of the first tubular component 10 was 0.04 mm, and the roundness of the second tubular component 20 was 0.05 mm. In comparison with the above-described comparative example, in the fourth example, since the projecting portions 12, especially the base portions 12b, deform, the deformation of the tubular portion 11 of the first tubular component 10 other than the projecting portions 12 was extremely small, and the deterioration of the roundness was reduced.

### Fifth Example

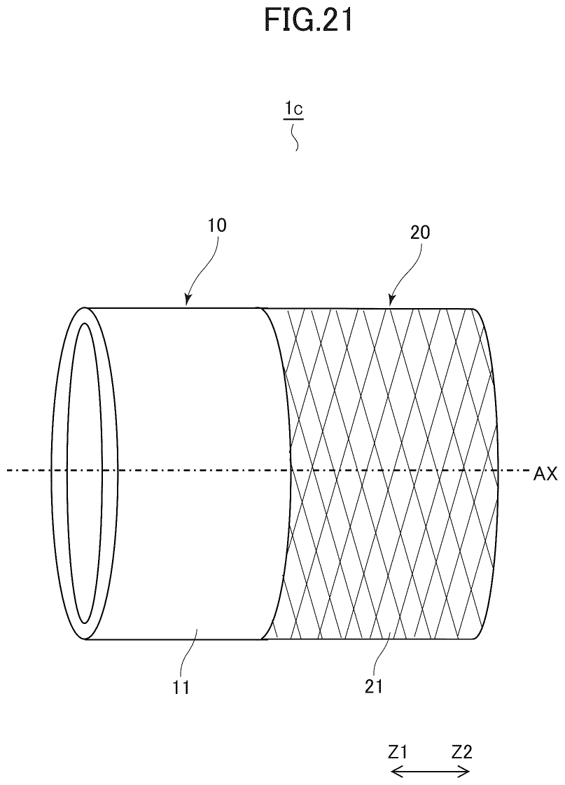

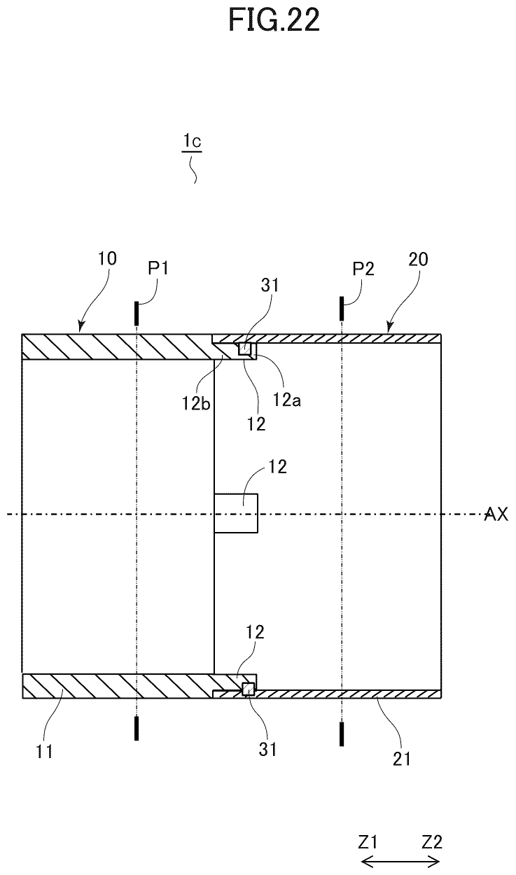

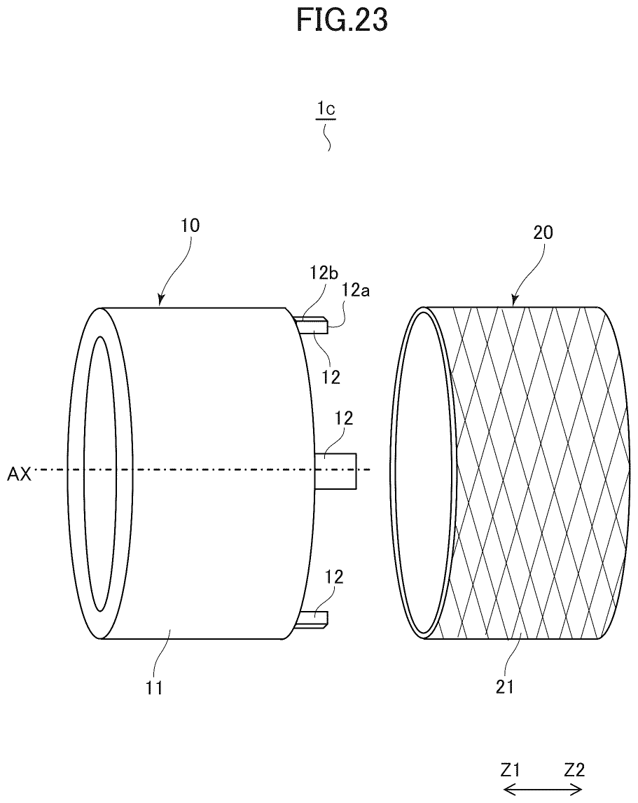

Next, a fifth example that is one example of the present embodiments will be described with reference to FIGS. 21, 22, and 23. FIG. 21 is a perspective view illustrating a composite cylinder member of the fifth example. FIG. 22 is a cross-sectional view illustrating the composite cylinder member of the fifth example. FIG. 23 is an exploded perspective view illustrating the composite cylinder member of the fifth example. Note that also in the description of the fifth example, a component identical to a component of the above-described first to third embodiments and the first to the fourth examples is given an identical symbol, and the description thereof will be omitted.

As illustrated in FIGS. 21, 22, and 23, in a composite cylinder member 1c of the fifth example, unlike in the composite cylinder member of the fourth example, the thickness of the distal end portion 12a of the projecting portion 12 and the thickness of the base portion 12b of the projecting portion 12 were made equal to each other, and were set at 1.5 mm. That is, no clearance was formed between the outer circumference side of the projecting portion 12 and the tubular portion 21 of the second tubular component 20. In addition, in the fifth example, the length of the tubular portion 11 of the first tubular component 10 in the axial direction was set at 100 mm, and the other shape was made equal to the shape of the tubular portion 11 of the fourth example. In addition, the area onto which the adhesive was applied in the joint portion 31 is also the same as that in the fourth example.

The joint portion 31 between the first tubular component 10 and the second tubular component 20 was formed in a position in which the projecting portion 12 of the first tubular component 10 and the inner circumference of the second tubular component 20 were in contact with each other in a state where the whole of the projecting portions 12 was inserted into the inner circumference side of the tubular portion 21 of the second tubular component 20. The first tubular component 10 and the second tubular component 20 were joined with each other by injecting adhesive into the clearance between the distal end portion 12a of the projecting portion 12 and the tubular portion 21 of the second tubular component 20.

After the first tubular component 10 and the second tubular component 20 were joined with each other, the roundness of each of the first tubular component 10 and the second tubular component 20 of the composite cylinder member 1c was measured. As a result, the roundness of the first tubular component 10 was 0.04 mm, and the roundness of the second tubular component 20 was 0.04 mm, which hardly differs from those in the above-described fourth example. In addition, in a state where the composite cylinder member 1_{C} of the fifth example was exposed to a high-temperature environment, the roundness of the first tubular component 10 was 0.8 mm, and the roundness of the second tubular component 20 was 0.09 mm. In addition, in a state where the composite cylinder member 1_{C} of the fifth example was exposed to a low-temperature environment, the roundness of the first tubular component 10 was 0.9 mm, and the roundness of the second tubular component 20 was 0.08 mm.

In the above-described fourth and fifth examples, since the roundness of the first tubular component 10 alone of the fourth example was almost equal to the roundness of the first tubular component 10 alone of the fifth example, and the roundness of the second tubular component 20 alone of the fourth example was almost equal to the roundness of the second tubular component 20 alone of the fifth example, the roundness of the composite cylinder member 1 changed less after the first tubular component 10 and the second tubular component 20 were joined with each other. However, in the low or high environment, the deterioration of the roundness was reduced more in the fourth example, in which the base portion 12b of the projecting portion 12 deforms. On the other hand, in the fifth example, since the projecting portions 12 are restricted by the tubular portion 21, there is no clearance that allows the base portion 12b to deform. Thus, the size of the whole of the composite cylinder member 1_{C} was changed by the change in temperature, so that the roundness was deteriorated. In the fifth example, however, since the projecting portions 12 were formed, the deformation of composite cylinder member 1_{C} caused by joining the first tubular component 10 and the second tubular component 20 was reduced, especially in the normal-temperature environment.

### Sixth Example

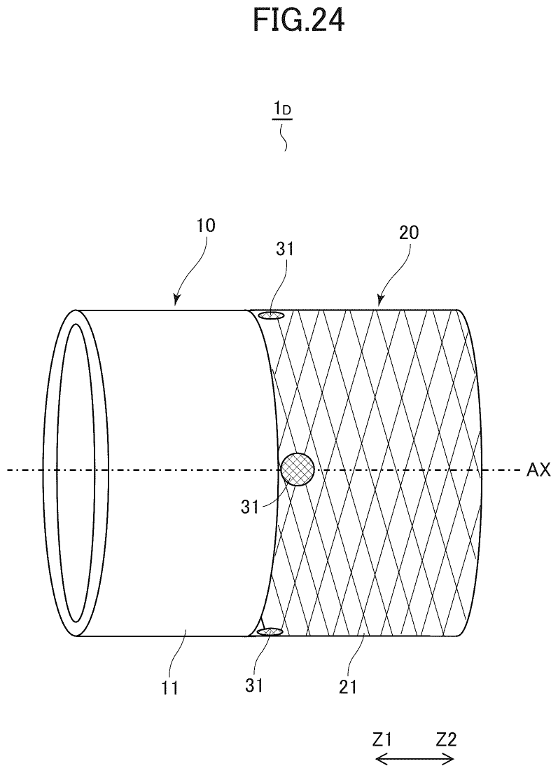

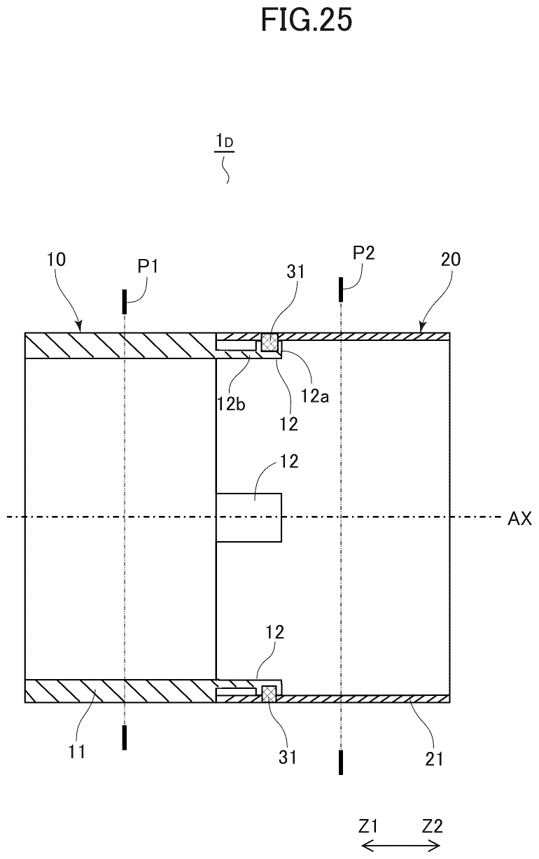

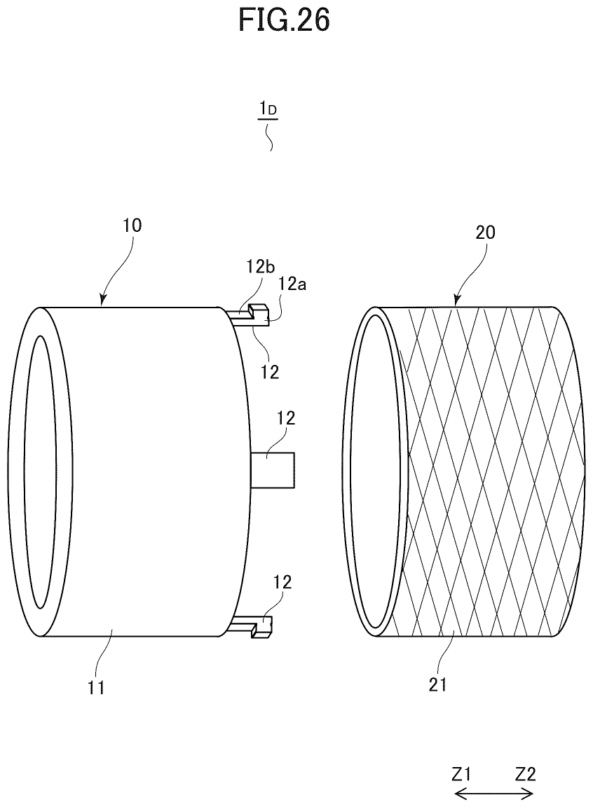

Next, a sixth example that is one example of the present embodiments will be described with reference to FIGS. 24, 25, and 26. FIG. 24 is a perspective view illustrating a composite cylinder member of the sixth example. FIG. 25 is a cross-sectional view illustrating the composite cylinder member of the sixth example. FIG. 26 is an exploded perspective view illustrating the composite cylinder member of the sixth example. Note that also in the description of the sixth example, a component identical to a component of the above-described first to third embodiments and the first to the fifth examples is given an identical symbol, and the description thereof will be omitted.

As illustrated in FIGS. 24, 25, and 26, also in a composite cylinder member 1_{D} of the sixth example, each of the first tubular component 10 and the second tubular component 20 has a cylindrical shape. The material and shape (size) of the first tubular component 10 are the same as those of the first tubular component 10 of the above-described fourth and fifth examples, and the material and shape (size) of the second tubular component 20 are the same as those of the second tubular component 20 of the above-described fourth and fifth examples.

The joint portion 31 between the first tubular component 10 and the second tubular component 20 was formed in a position in which the distal end portion 12a of the projecting portion 12 of the first tubular component 10 and the inner circumference of the second tubular component 20 were in contact with each other in a state where the whole of the projecting portions 12 was inserted into the inner circumference side of the tubular portion 21 of the second tubular component 20. In the joint portion 31, the first tubular component 10 and the second tubular component 20 were joined with each other by thermally welding the distal end portion 12a of the projecting portion 12 and the inner circumferential surface of the tubular portion 21 of the second tubular component 20. In the thermal welding, for joining the first tubular component 10 and the second tubular component 20, the polycarbonate of the first tubular component 10 and the polycarbonate of the second tubular component 20 were melted and mixed with each other by heating a bar-like jig having a diameter of 5 mm to 300° C. and by pressing the jig against the outer circumference of the second tubular component 20 in the inner-and-outer diameter direction, with a force of 10 kg, for 5 seconds.

In the sixth example, the jig was pressed against the joint portion 31 from the second tubular component 20 side. Since the second tubular component 20 was made of the CFRTP that contains continuous fiber having high thermal conductivity, the heat was conducted to the distal end portion 12a of the projecting portion 12 of the first tubular component 10 that was made of the other thermoplastic resin. As a result, in the sixth example, the bonding force stronger than the bonding force produced by the adhesive as in the above-described first to fifth examples was produced.

After the first tubular component 10 and the second tubular component 20 were joined with each other, the roundness of each of the first tubular component 10 and the second tubular component 20 of the composite cylinder member 1_{D} was measured. As a result, the roundness of the first tubular component 10 was 0.04 mm, and the roundness of the second tubular component 20 was 0.05 mm. In addition, in a state where the composite cylinder member 1_{D} in which the first tubular component 10 and the second tubular component 20 were joined with each other was exposed to a high-temperature environment, the roundness of the first tubular component 10 was 0.04 mm, and the roundness of the second tubular component 20 was 0.05 mm. In addition, in a state where the composite cylinder member 1_{D} was exposed to a low-temperature environment, the roundness of the first tubular component 10 was 0.04 mm, and the roundness of the second tubular component 20 was 0.05 mm. In comparison with the above-described comparative example, in the sixth example, since the projecting portions 12, especially the base portions 12b, deform, the deformation of the tubular portion 11 of the first tubular component 10 other than the projecting portions 12 was extremely small, and the deterioration of the roundness was reduced.

### Seventh Example

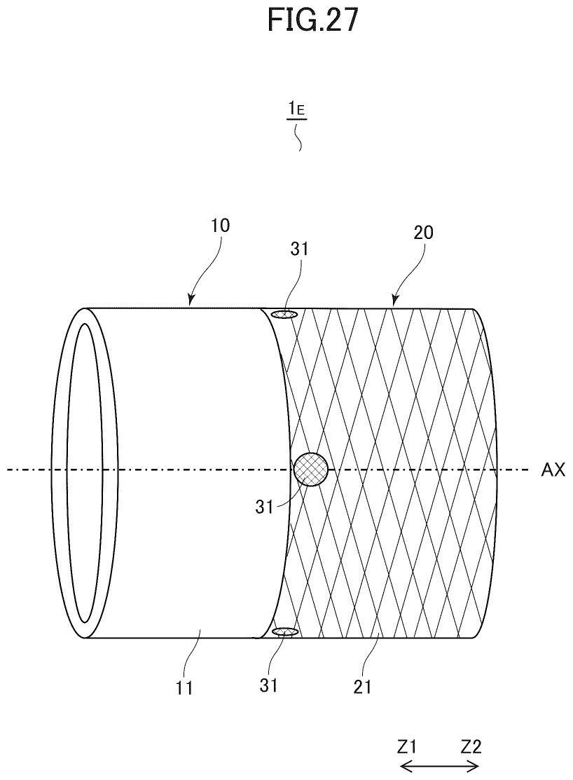

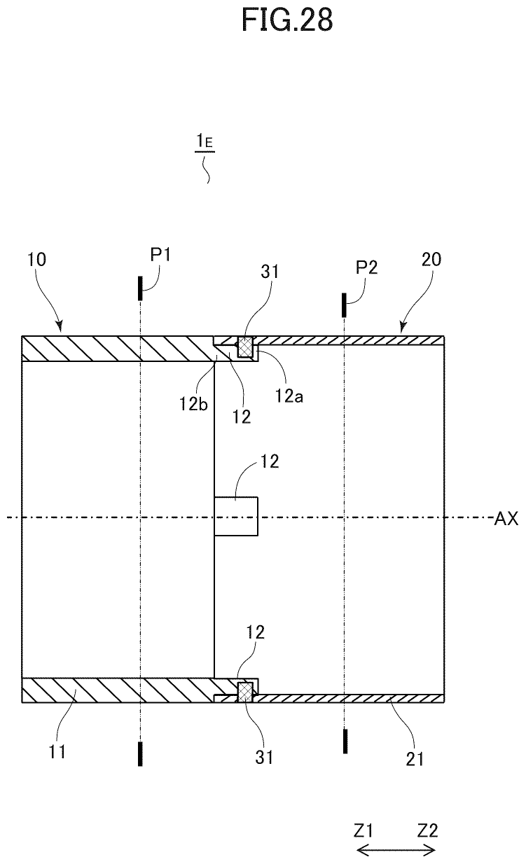

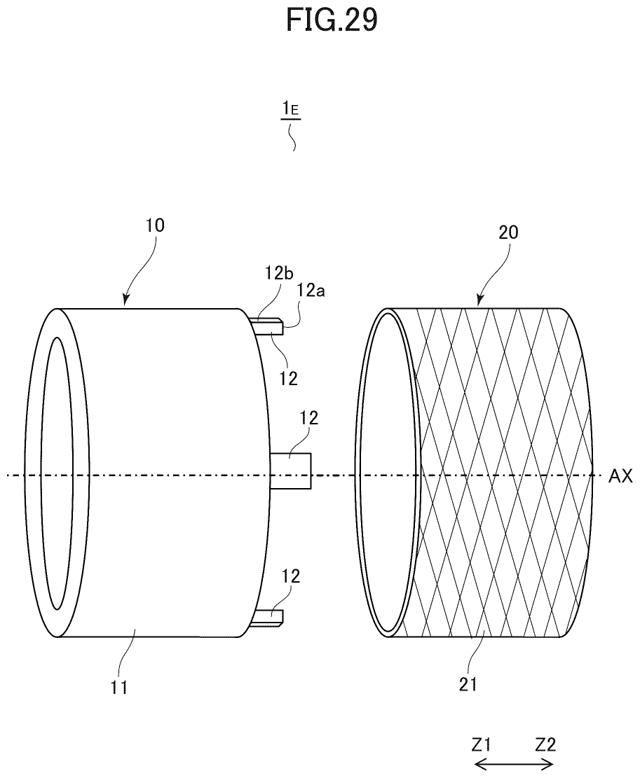

Next, a seventh example that is one example of the present embodiments will be described with reference to FIGS. 27, 28, and 29. FIG. 27 is a perspective view illustrating a composite cylinder member of the seventh example. FIG. 28 is a cross-sectional view illustrating the composite cylinder member of the seventh example. FIG. 29 is an exploded perspective view illustrating the composite cylinder member of the seventh example. Note that also in the description of the seventh example, a component identical to a component of the above-described first to third embodiments and the first to the sixth examples is given an identical symbol, and the description thereof will be omitted.

As illustrated in FIGS. 27, 28, and 29, in a composite cylinder member 1E of the seventh example, unlike in the composite cylinder member of the above-described sixth example, the thickness of the distal end portion 12a of the projecting portion 12 and the thickness of the base portion 12b of the projecting portion 12 were made equal to each other, and were set at 1.5 mm. That is, no clearance was formed between the outer circumference side of the projecting portion 12 and the tubular portion 21 of the second tubular component 20. In addition, in the seventh example, the length of the tubular portion 11 of the first tubular component 10 in the axial direction was set at 100 mm, and the other shape was made equal to the shape of the tubular portion 11 of the sixth example.

The joint portion 31 between the first tubular component 10 and the second tubular component 20 was formed in a position in which the projecting portion 12 of the first tubular component 10 and the inner circumference of the second tubular component 20 were in contact with each other in a state where the whole of the projecting portions 12 was inserted into the inner circumference side of the tubular portion 21 of the second tubular component 20. In addition, as in the above-described sixth example, the composite cylinder member 1E was formed (that is, the first tubular component 10 and the second tubular component 20 were joined with each other) by performing the thermal welding at four joint portions 31 formed at intervals of 90 degrees around a circle (i.e., in the circumferential direction). The jig, conditions, and processing condition and method of the thermal welding are the same as those in the above-described sixth example.

Also in the seventh example, the jig was pressed against the joint portion 31 from the second tubular component 20 side. Since the second tubular component 20 was made of the CFRTP that contains continuous fiber having high thermal conductivity, the heat was conducted to the distal end portion 12a of the projecting portion 12 of the first tubular component 10 that was made of the other thermoplastic resin. As a result, in the seventh example, the bonding force stronger than the bonding force produced by the adhesive as in the above-described first to fifth examples was produced.

After the first tubular component 10 and the second tubular component 20 were joined with each other, the roundness of each of the first tubular component 10 and the second tubular component 20 of the composite cylinder member 1E was measured. As a result, the roundness of the first tubular component 10 was 0.04 mm, and the roundness of the second tubular component 20 was 0.04 mm, which hardly differs from those in the above-described sixth example. In addition, in a state where the composite cylinder member 1E of the seventh example was exposed to a high-temperature environment, the roundness of the first tubular component 10 was 0.8 mm, and the roundness of the second tubular component 20 was 0.09 mm. In addition, in a state where the composite cylinder member 1E of the seventh example was exposed to a low-temperature environment, the roundness of the first tubular component 10 was 0.9 mm, and the roundness of the second tubular component 20 was 0.08 mm.

In the above-described sixth and seventh examples, since the roundness of the first tubular component 10 alone of the sixth example was almost equal to the roundness of the first tubular component 10 alone of the seventh example, and the roundness of the second tubular component 20 alone of the sixth example was almost equal to the roundness of the second tubular component 20 alone of the seventh example, the roundness of the composite cylinder member 1 changed less after the first tubular component 10 and the second tubular component 20 were joined with each other. However, in the high or low environment, the deterioration of the roundness was reduced more in the above-described sixth example, in which the base portion 12b of the projecting portion 12 deforms. On the other hand, in the seventh example, since the projecting portions 12 are restricted by the tubular portion 21, there is no clearance that allows the base portion 12b to deform. Thus, the size of the whole of the composite cylinder member 1E was changed by the change in temperature, so that the roundness was deteriorated. In the seventh example, however, since the projecting portions 12 were formed, the deformation of composite cylinder member 1E caused by joining the first tubular component 10 and the second tubular component 20 was reduced, especially in the normal-temperature environment.

### Fourth Embodiment

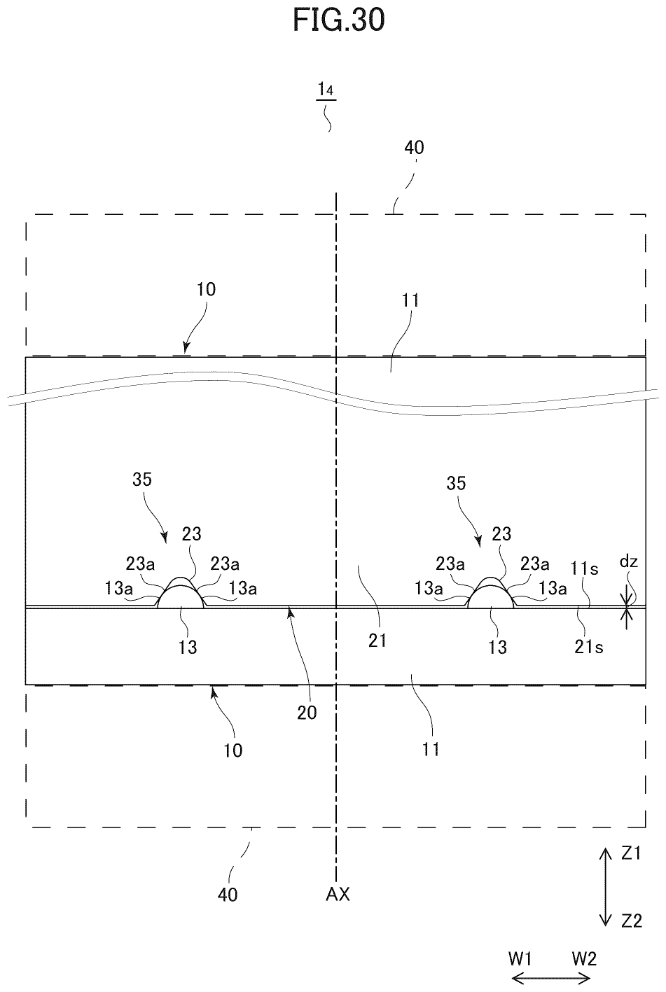

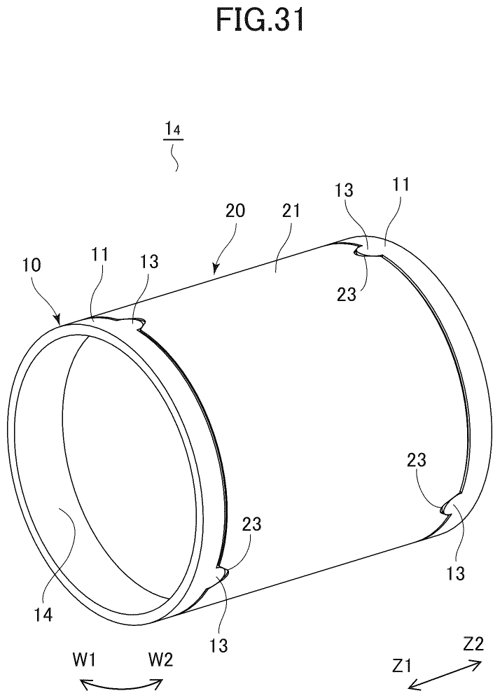

Hereinafter, a fourth embodiment for embodying the present disclosure will be described with reference to FIGS. 30 and 31. FIG. 30 is a front view illustrating a composite cylinder member of the fourth embodiment. FIG. 31 is a perspective view illustrating the composite cylinder member of the fourth embodiment. A composite cylinder member 14 of the fourth embodiment includes a base component 40, a first tubular component 10, and a second tubular component 20. In FIG. 31, however, the base component 40 is not illustrated.

For example, in a cylindrical joined member in which two cylindrical components having different coefficients of linear expansion are joined with each other, the deterioration in accuracy of the component may be caused by the stress produced by the difference in the coefficient of linear expansion, which is caused by the change in temperature. For this reason, Japanese Patent Application Publication No. H9-303707 proposes a configuration in which two components are abutted against each other such that sliding surfaces of the components (i.e., a sliding outer surface and a sliding inner surface) slide on each other in a direction in which the components expand due to thermal expansion. In addition, Japanese Patent Application Publication No. 2009-278823 proposes a configuration in which a clearance is formed for absorbing the influence caused by the difference in expansion between two components.

In the above-described configuration in which the sliding surfaces of two components are abutted against each other so that the sliding surfaces slide on each other, the expansion (contraction) of the components caused by thermal expansion (thermal contraction) is allowed to some extent. However, since the expansion (contraction) is received by the sliding surface, the deterioration in accuracy may be caused by the thermal expansion. On the other hand, in the configuration in which the clearance is formed between two components for preventing the influence caused by the difference in thermal expansion (thermal contraction) between the components, although the deterioration in accuracy caused by the thermal expansion (thermal contraction) can be prevented, the components may wobble. The below-described embodiments and example aim to provide a joined member that can prevent the deterioration in accuracy and reduce the wobble in a case where a first cylinder member and a second cylinder member having different coefficients of linear expansion are joined with each other, and a method of manufacturing the joined member.

As illustrated in FIGS. 30 and 31, the composite cylinder member 14 of the fourth embodiment that serves as a joined member is an exterior component that constitutes a lens barrel or a hood of an interchangeable lens used in, for example, a single-lens reflex camera. The composite cylinder member 14 includes the base component 40, two first tubular components 10, and a second tubular component 20, which are coaxially arranged on a central axis AX. The base component 40 is a cylindrical outer case (i.e., lens barrel) of an optical apparatus, which accommodates a plurality of optical lenses. The two first tubular components 10 and the second tubular component 20 are supported by the base component 40. In particular, the second tubular component 20 is supported such that the second tubular component 20 is held by the two first tubular components 10 from outer sides in the axial direction. The first tubular component 10 is a molded body made of a material, such as a resin, whose coefficient of linear expansion is higher than that of the second tubular component 20. That is, the first tubular component 10 is a high-linear-expansion-coefficient molded body. In contrast, the second tubular component 20 is a molded body made of a material, such as a resin, whose coefficient of linear expansion is lower than that of the first tubular component 10. That is, the second tubular component 20 is a low-linear-expansion-coefficient molded body.

The first tubular component 10 includes a cylinder-shaped tubular portion 11. On the outer circumference side of the tubular portion 11, a first end surface 11s is formed so as to face an axial direction. In addition, as illustrated in FIG. 31, on the inner circumference side of the tubular portion 11 with respect to the first end surface 11s, an inner-circumference tubular portion 14 is formed integrally with the tubular portion 11, so as to extend from the first end surface 11s toward the second tubular component 20 in the axial direction. In other words, the first end surface 11s is formed in the tubular portion 11 like a step, on the outer circumference side of the inner-circumference tubular portion 14. In addition, projection portions 13 are formed in the tubular portion 11 of the first tubular component 10, so as to project from the first end surface 11s in the axial direction such that each projection portion 13 form a convex shape. The projection portions 13 are spaced evenly from each other in the circumferential direction, and formed, for example, at four positions (at intervals of 90 degrees).

The second tubular component 20 includes a cylinder-shaped tubular portion 21. The tubular portion 21 is loosely fit to the outer circumference of the inner-circumference tubular portion 14 of the first tubular component 10. That is, if the inner-circumference tubular portion 14 of the first tubular component 10 and the tubular portion 21 of the second tubular component 20 are fit to each other via no clearance, the deterioration in accuracy (roundness) may be caused by the stress that is produced by the difference in the amount of expansion, which is caused by the change in temperature. For this reason, the slight clearance is formed between the inner-circumference tubular portion 14 of the first tubular component 10 and the tubular portion 21 of the second tubular component 20, and the inner-circumference tubular portion 14 of the first tubular component 10 and the tubular portion 21 of the second tubular component 20 are loosely fit to each other.

On one end of the tubular portion 21 of the second tubular component 20 in the axial direction, a second end surface 21s is formed. The second end surface 21s and the above-described first end surface 11s are disposed so as to face each other in the axial direction in a state where the first tubular component 10 and the second tubular component 20 are joined with each other, and form a clearance dz in the axial direction (i.e., a Z1-Z2 direction). The clearance dz serves as a first clearance. In other words, the first tubular component 10 and the second tubular component 20 are joined with each other by the base component 40 holding the first tubular component 10 and the second tubular component 20, such that the clearance dz is formed between the second end surface 21s and the above-described first end surface 11s. Thus, the first tubular component 10 and the second tubular component 20 have the clearance dz formed between the first tubular component 10 and the second tubular component 20 in the axial direction that is a direction in which the first end surface 11s and the second end surface 21s face each other. In addition, the first tubular component 10 and the second tubular component 20 are loosely fit to each other such that the first tubular component 10 and the second tubular component 20 have a clearance (not illustrated) formed in the circumferential direction. Thus, the first tubular component 10 and the second tubular component 20 can relatively move with respect to each other in the axial direction and the inner-and-outer diameter direction. That is, even if the first tubular component 10 that is a high-linear-expansion-coefficient molded body thermally expands or contracts, the first tubular component 10 and the second tubular component 20 do not interfere with each other, and do not affect the accuracy.

In addition, in the above-described second end surface 21s, recess portions 23 that are recessed in the axial direction are formed. Each recess 23 fits to a corresponding one of the above-described projection portions 13, and the recess portion 23 and the projection portion 13 form a fit portion 35. Specifically, the projection portion 13 of the first tubular component 10 has a semicircular shape when viewed in the radial direction, and the recess portion 23 is formed so as to have a triangular shape when viewed in the radial direction. That is, the recess portion 23 includes two sloped surfaces that form a shape that broadens, when viewed in the radial direction, roughly toward a direction toward which the shape is opened. Thus, the projection portion 13 and the recess portion 23 are fit to each other such that contact portions 13a and 13a of the projection portion 13, which are two arc-shaped surfaces, are in contact with contact portions 23a and 23a of the recess portion 23, which are two sloped surfaces. In this manner, in the fit portion 35, the first tubular component 10 and the second tubular component 20 are engaged with each other such that the projection portions 13 of the first tubular component 10 and the recess portions 23 of the second tubular component 20 fit to each other. Thus, even though the clearance dz is formed as described above, the first tubular component 10 and the second tubular component 20 can be prevented from wobbling in the axial direction (i.e., the Z1-Z2 direction) and the circumferential direction (i.e., a W1-W2 direction).

For example, in a case where the composite cylinder member 14 is exposed to a high-temperature environment (the temperature of the composite cylinder member 14 increases), the base component 40 and the first tubular component 10 that have high coefficients of linear expansion expand, and the second tubular component 20 that has a low coefficient of linear expansion hardly expands (or may slightly contract). In this case, the two first tubular components 10 supported by the base component 40 move with respect to each other in the axial direction, toward directions in which the two first tubular components 10 are relatively separated from the second tubular component 20. However, since the projection portions 13 mainly expand, the contact state between the projection portions 13 and the recess portions 23 is kept. That is, the fit state is kept.

In contrast, in a case where the composite cylinder member 14 is exposed to a low-temperature environment (the temperature of the composite cylinder member 14 decreases), the base component 40 and the first tubular component 10 that have high coefficients of linear expansion contract, and the second tubular component 20 that has a low coefficient of linear expansion hardly contracts (or may slightly expand). In this case, the two first tubular components 10 supported by the base component 40 move with respect to each other in the axial direction, toward directions in which the two first tubular components 10 move closer to the second tubular component 20. However, since the projection portions 13 mainly contract, the contact state is kept without producing excessive pressure on the recess portions 23. That is, the fit state is kept.

As described above, in the composite cylinder member 14 of the fourth embodiment, since the first tubular component 10 and the second tubular component 20 have the clearance in both of the axial direction and the inner-and-outer diameter direction, the accuracy (roundness) can be prevented from being affected by the thermal expansion or thermal contraction. In addition, even though the clearance is formed between the first tubular component 10 and the second tubular component 20, the projection portions 13 and the recess portions 23 are fit to each other in the fit portion 35 in both of the high-temperature environment and the low-temperature environment. As a result, the occurrence of the wobble can be reduced. In particular, even if the first tubular component 10 contracts, in the low-temperature environment, toward a direction in which the first tubular component 10 moves closer to the second tubular component 20, the projection portions 13 also contract. As a result, any excessive pressure is not produced on the recess portions 23, and the accuracy (roundness) can be prevented from being affected.

Note that it is preferable that of the second tubular component 20, which is a low-linear-expansion-coefficient molded body, be a continuous-carbon-fiber reinforced molded resin body. The type of the fiber of the continuous-carbon-fiber reinforced molded resin body may be any material, such as carbon fiber, glass fiber, boron fiber, or organic fiber such as aramid fiber. In addition, the type of resin impregnant of the continuous-carbon-fiber reinforced molded resin body may be any resin impregnant. That is, the type of resin impregnant of the continuous-carbon-fiber reinforced molded resin body may be polyamide resin (PA), polycarbonate resin (PC), acrylic resin (PMMA), polyether ether ketone (PEEK), polyphenylene sulfide (PPS), or polypropylene (PP) if the resin impregnant is a thermoplastic resin. In another case, if the resin impregnant is a thermosetting resin, the type of resin impregnant may be epoxy resin, phenol resin, unsaturated polyester resin, or vinyl ester resin. More preferably, the type of resin impregnant of the continuous-carbon-fiber reinforced molded resin body is PC for allowing the continuous-carbon-fiber reinforced resin to have excellent strength and toughness. In this case, the sizing agent may be used for increasing affinity between the continuous carbon fiber and the resin impregnant, and it is preferable that the continuous-carbon-fiber bundle be opened.

In addition, it is preferable that the first tubular component 10, which is a high-linear-expansion-coefficient molded body, is a molded resin product. Preferably, the material of the molded resin product is any type of thermoplastic resin, such as PA, PC, PMMA, PEEK, PPS, or PP. If the molded resin product is made of a fiber reinforced resin that contains 10 to 30% of short glass fiber or carbon fiber, the strength of the molded resin product can be increased.

In the composite cylinder member 14 of the fourth embodiment, four projection portions 13 are formed in the first tubular component 10, and four recess portions 23 are formed in the second tubular component 20. However, the present disclosure is not limited to this. That is, the number of each of the projection portions 13 and the recess portions 23 may be any number as long as three or more projection portions 13 and three or more recess portions 23 are formed so that three points (among others) of each of the first tubular component 10 and the second tubular component 20 are fixed on a plane orthogonal to the axial direction.

### Fifth Embodiment

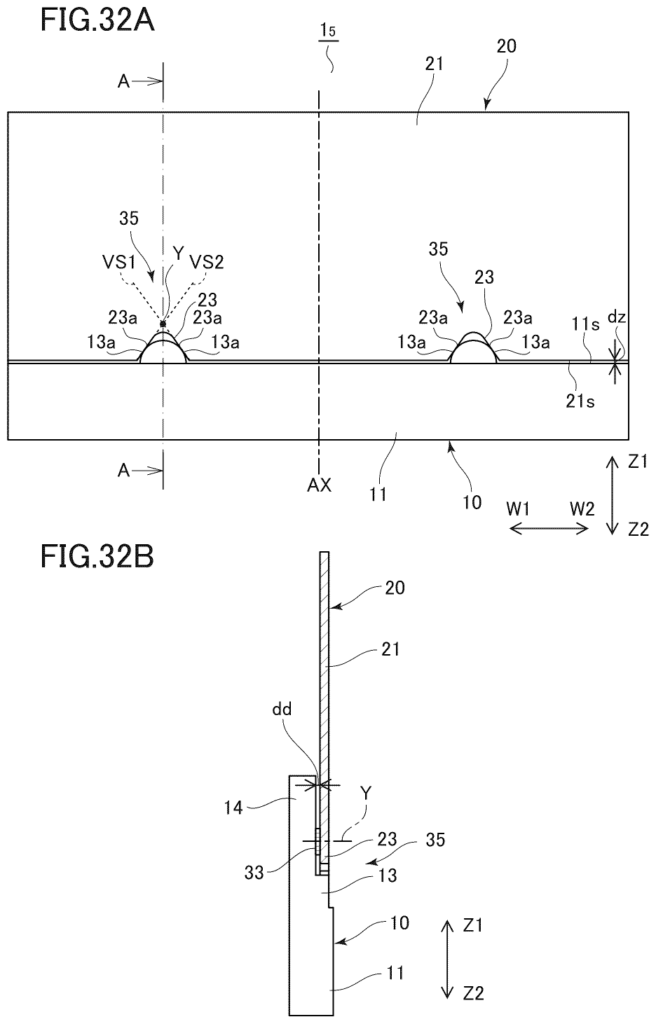

Next, a fifth embodiment will be described with reference to FIGS. 32A and 32B. In the fifth embodiment, part of the above-described fourth embodiment is changed. FIG. 32A is a front view illustrating a composite cylinder member of the fifth embodiment. FIG. 32B is a cross-sectional view taken along a line indicated by arrows A-A in FIG. 32A. Note that in the description of the fifth embodiment, a component identical to a component of the above-described fourth embodiment is given an identical symbol, and the description thereof will be omitted.

As illustrated in FIGS. 32A and 32B, unlike in the composite cylinder member 14 of the fourth embodiment, in a composite cylinder member 15 of the fifth embodiment that serves as a joined member, the first tubular component 10 and the second tubular component 20 are joined with each other in a joint portion 33.

Specifically, as illustrated in FIG. 32A, in the composite cylinder member 15, a position Y is positioned at a position at which an imaginary plane VS1 including one of the two sloped surfaces (i.e., a contact portion 23a) of the recess portion 23 and an imaginary plane VS2 including the other (i.e., a contact portion 23a) of the recess portion 23 intersect with each other. As illustrated in FIG. 32B, the joint portion 33 is disposed on the inner circumference side of a portion of the tubular portion 21 formed at the position Y. That is, the joint portion 33 is formed on the inner circumference side of the portion formed at the position Y, by injecting adhesive into a clearance dd formed between the tubular portion 21 of the second tubular component 20 and the inner-circumference tubular portion 14 of the tubular portion 11 of the first tubular component 10 in the inner-and-outer diameter direction. The clearance dd serves as a second clearance. Note that the first tubular component 10 and the second tubular component 20 may be joined with each other in the joint portion 33 while pressure is applied to the first tubular component 10 and the second tubular component 20 in the axial direction (i.e., the Z1-Z2 direction) to the extent that the projection portions 13 and the recess portions 23 are not damaged.

That is, in a case where the first tubular component 10 and the second tubular component 20 are merely held by the base component 40 (see FIG. 30), if the force is applied to the first tubular component 10 in the circumferential direction (i.e., the W1-W2 direction) relative to the second tubular component 20, the recess portions 23 may be disengaged from the projection portions 13. However, in the composite cylinder member 15 of the fifth embodiment, even if the force is applied to the first tubular component 10 in the circumferential direction (i.e., the W1-W2 direction), the projection portions 13 can be prevented from being disengaged from the recess portions 23, by the joining in the joint portion 33. In contrast, in a case where the joint portion is formed in a position other than the position Y, if the force is applied to the first tubular component 10 in the circumferential direction, the moment of rotation is produced, with the joint portion serving as a fulcrum, so that the recess portions are easily disengaged from the projection portions 13. However, since the first tubular component 10 and the second tubular component 20 are joined with each other at the position Y, the moment of rotation can be received by the sloped surfaces of the recess portion 23 even if the force is applied to the first tubular component 10 in the circumferential direction. As a result, it becomes difficult for the contact portions 13a of the projection portion 13 to disengage from the contact portions 23a of the recess portion 23.

Note that in the composite cylinder member 15 of the fifth embodiment, the first tubular component 10 and the second tubular component 20 are joined with each other in the joint portion 33, via adhesive. However, the present disclosure is not limited to this. For example, a boss-shaped portion may be formed on a portion of the inner-circumference tubular portion 14 of the first tubular component 10, formed at the position Y, and the boss-shaped portion and the second tubular component 20 may be heat-sealed to each other.

### Sixth Embodiment

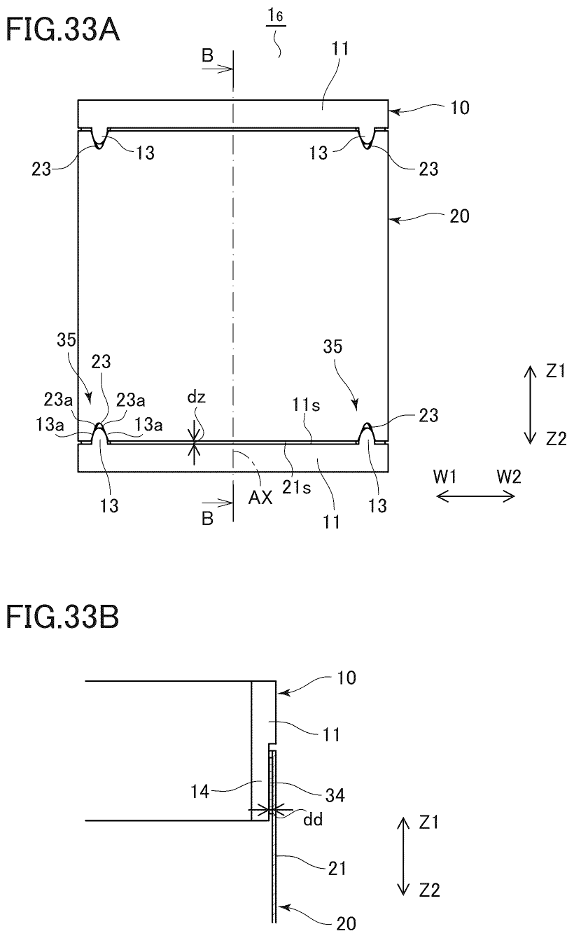

Next, a sixth embodiment will be described with reference to FIGS. 33A and 33B. In the sixth embodiment, part of the above-described fourth embodiment is changed. FIG. 33A is a front view illustrating a composite cylinder member of the sixth embodiment. FIG. 33B is a cross-sectional view taken along a line indicated by arrows B-B in FIG. 33A. Note that in the description of the sixth embodiment, a component identical to a component of the above-described fourth embodiment is given an identical symbol, and the description thereof will be omitted.

As illustrated in FIGS. 33A and 33B, unlike in the composite cylinder member 14 of the fourth embodiment, in a composite cylinder member 16 of the sixth embodiment that serves as a joined member, an elastic member 34 is disposed between the first tubular component 10 and the second tubular component 20.

Specifically, as illustrated in FIGS. 33A and 33B, in the composite cylinder member 16, the elastic member 34 is disposed in a clearance dd formed between the inner circumferential surface of the tubular portion 21 of the second tubular component 20 and the outer circumferential surface of the inner-circumference tubular portion 14 of the tubular portion 11 of the first tubular component 10 in the inner-and-outer diameter direction. That is, the elastic member 34 is disposed so as to circle a portion of the first tubular component 10 and the second tubular component 20, other than the fit portions 35, in the circumferential direction; and keeps a state where the first tubular component 10 and the second tubular component 20 are allowed to move with respect to each other within a predetermined range of distance, by the elastic deformation of the elastic member 34.

If the Shore A of rubber hardness (Durometer Type A) of the elastic member 34 is lower than 20 degrees, a human user will have the feeling of a gap when holding the exterior component of a lens barrel because the elastic member is too soft. As a result, the grade of the lens barrel will deteriorate. In contrast, if the Shore A of rubber hardness of the elastic member 34 is higher than 80 degrees, the stress produced by the difference, in the amount of linear expansion, between the first tubular component 10 and the second tubular component 20 is transmitted to the first tubular component 10 or the second tubular component 20 when the temperature changes. This is because the elastic member 34 has a high modulus of elasticity. As a result, the accuracy will deteriorate. The relationship between the Shore A of rubber hardness, the deterioration of accuracy caused by the change in temperature, and the feeling of a gap felt by a user when holding the exterior component is shown in the following Table 1.

TABLE 1

| SHORE A OF | 20 | 50 | 80 | 10 | 90 |
|---|---|---|---|---|---|
| RUBBER HARDNESS | DEGREES | DEGREES | DEGREES | DEGREES | DEGREES |
| CHANGE IN ACCURACY IN | good | good | good | good | poor |
| TEMPERATURE CHANGE | | | | | |
| FEELING OF GAP WHEN | good | good | good | poor | good |
| HOLDING EXTERIOR | | | | | |
| COMPONENT | | | | | |

As shown in Table 1, it is preferable that the Shore A of rubber hardness of the elastic member 34, which serves as rubber hardness, be in a range from 20 to 80 degrees. In this manner, the grade of the exterior component of the lens barrel can be kept high, and the deterioration of the accuracy can be prevented.

Note that if the material of the elastic member 34 is rubber or the like, the material may be any rubber material, such as natural rubber (NR), styrene-butadiene rubber (SBR), nitrile rubber (NBR), ethylene-propylene rubber (EPDM), silicone rubber, fluororubber, or urethane rubber.

In another case, the elastic member 34 may have adhesiveness, and join the first tubular component 10 and the second tubular component 20. In this case, it is preferable that a portion of the elastic member 34 formed at the position Y (see FIGS. 32A and 32B), as in the above-described fifth embodiment, and on the inner circumference side have adhesiveness.

### Eighth Example

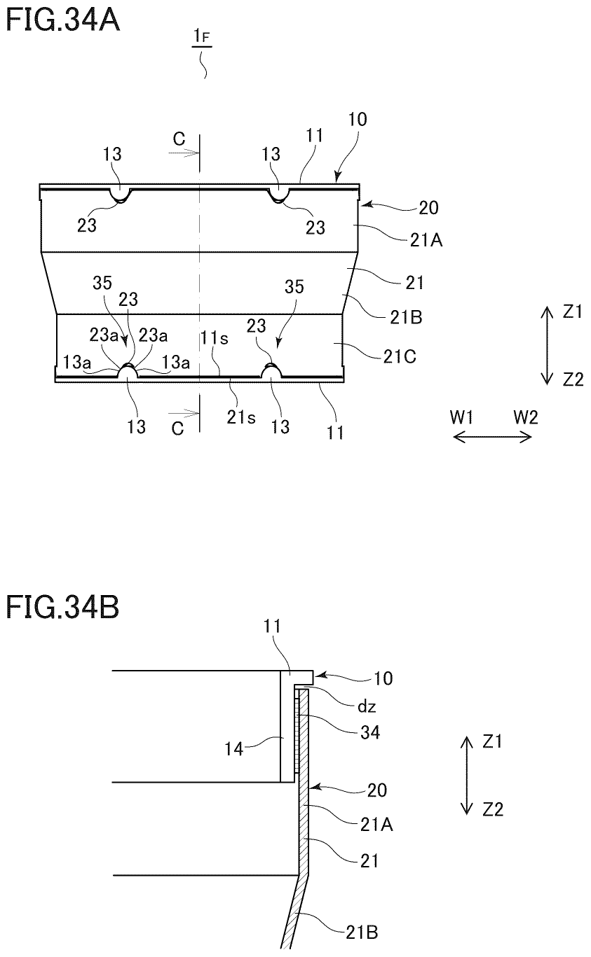

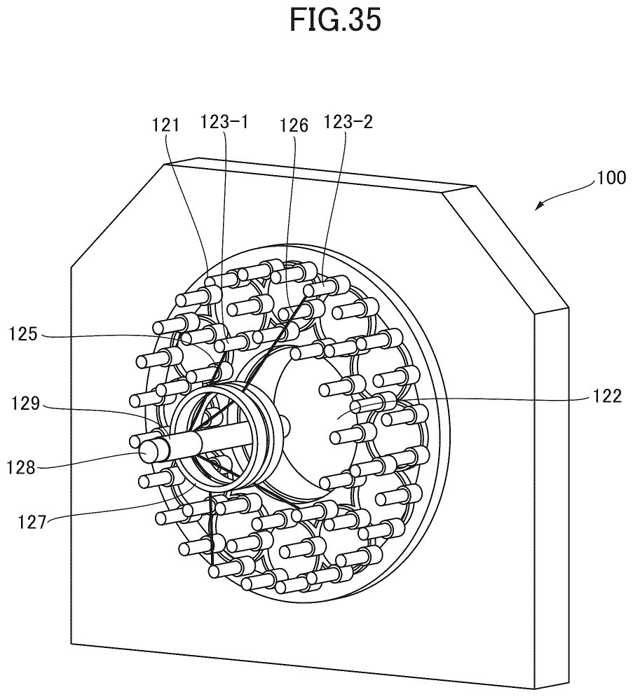

Next, an eighth example that is one example of the above-described sixth embodiment will be described with reference to FIGS. 34A, 34B, and 35. FIG. 34A is a front view illustrating a composite cylinder member of the eighth example. FIG. 34B is a cross-sectional view taken along a line indicated by arrows C-C in FIG. 34A. FIG. 35 is a perspective view illustrating one example of a braiding apparatus. Note that in the description of the eighth example, a component identical to a component of the above-described fourth and sixth embodiments is given an identical symbol, and the description thereof will be omitted.

First, a method of manufacturing the second tubular component 20, that is, a method of manufacturing the continuous-carbon-fiber reinforced molded resin body that serves as a low-linear-expansion-coefficient molded body will be described with reference to FIG. 35.

As illustrated in FIG. 35, a braiding apparatus 100 includes an annular frame 121 in which a through-hole 122 is formed, a mandrel 128 inserted in the through-hole 122, and a guide ring 127 disposed around the outer circumference of the mandrel 128. The annular frame 121 includes a moving mechanism (not illustrated) that moves a plurality of carriers 123 in an 8-shaped trajectory 124. The plurality of carriers 123 supply continuous-carbon-fiber reinforced resin tapes 125 and 126.

Specifically, each of the carriers 123 includes a bobbin (not illustrated), and the continuous-carbon-fiber reinforced resin tape 125 or 126 is wound around the bobbin in advance. The continuous-carbon-fiber reinforced resin tapes 125 and 126, wound around the bobbins in advance, are drawn out from the carriers 123, and bent toward desired braiding-angle directions and guided toward the mandrel 128, by the guide ring 127. Note that each of the carriers 123 includes a mechanism (not illustrated) that produces the tension by using a spring force or the like. By the tension, the continuous-carbon-fiber reinforced resin tapes 125 and 126 are wound around the mandrel 128 such that the continuous-carbon-fiber reinforced resin tapes 125 and 126 are arranged to each other.

In addition, the plurality of carriers 123 move along the 8-shaped trajectory 124 formed on the annular frame 121. That is, the direction in which half of the carriers 123 move is opposite to the direction in which the other half of the carriers 123 move. For example, the rotational trajectory on which a carrier 123-1 moves is opposite to the rotational trajectory on which a carrier 123-2 moves. With the movement of the carriers, the continuous-carbon-fiber reinforced resin tapes 125 and 126 intersect with each other, so that a continuous-carbon-fiber reinforced resin layer 129 is formed on the mandrel 128.

In this example, the width of each of the continuous-carbon-fiber reinforced resin tapes 125 and 126 was set at 9 mm, and the VF value (i.e., the fiber volume content) of each of the continuous-carbon-fiber reinforced resin tapes 125 and 126 was set at 50%. In addition, in the braiding, the state of each of the continuous-carbon-fiber reinforced resin tapes 125 and 126 was set to a semi-impregnated state because each of the continuous-carbon-fiber reinforced resin tapes 125 and 126 was required to have flexibility. The density in the semi-impregnated state was set at a value in a range from 50 to 60%. The resin impregnant contained in the continuous-carbon-fiber reinforced resin tapes 125 and 126 is a PC whose viscosity-average molecular weight is 20000. The continuous-carbon-fiber reinforced resin tapes 125 and 126 were made by forming a prepreg sheet and cutting the sheet into tapes. The prepreg sheet was made by integrating a continuous-carbon-fiber sheet material, whose continuous carbon fiber was opened, and a PC film with each other, by putting the continuous-carbon-fiber sheet material and the PC film between heating rollers or the like.

Then, an impregnating process was performed. In the impregnating process, the continuous-carbon-fiber reinforced resin layer 129 was heated by using a heating unit (not illustrated), then the resin impregnant contained in the continuous-carbon-fiber reinforced resin tapes 125 and 126 was melted and impregnated into the space between the fibers, by using a pressing unit (not illustrated). After that, the continuous-carbon-fiber reinforced resin layer 129 was cooled in the impregnating process, so that the second tubular component 20 that is a continuous-carbon-fiber reinforced molded resin body (i.e., a low-linear-expansion-coefficient molded body) was formed. Then, the second tubular component 20 that is a continuous-carbon-fiber reinforced molded resin body was removed from the mandrel 128, and six recess portions 23 were formed on each of both sides of the second tubular component 20, in the circumferential direction, by cutting end surfaces of both sides of the tubular portion 21 toward the axial direction by using a machine tool.

Next, a method of manufacturing the first tubular component 10 that is a high-linear-expansion-coefficient molded body will be described. The first tubular component 10 is a molded resin product. The first tubular component 10 was manufactured by performing the injection molding by using a mold (not illustrated). In addition, six projection portions 13 that include the contact portions 13a, each having the arc-shaped surface, were formed in the circumferential direction, by using the shape of the mold. The material of the molded resin product is a PC (i.e., Panlite G-3430H made by TEIJIN LIMITED) that contains 30% of glass short fiber.

As illustrated in FIG. 34A, in a composite cylinder member 1_{F} of the eighth example, two first tubular components 10 and the second tubular component 20 are supported by a base component (not illustrated) in a state where the second tubular component 20 is held by the two first tubular components 10. The second tubular component 20 includes a large-diameter portion 21A whose diameter is 100 mm, a small-diameter portion 21C whose diameter is 90 mm and smaller than that of the large-diameter portion 21A, and a tapered portion 21B which has a tapered shape formed so as to connect the large-diameter portion 21A and the small-diameter portion 21C.

In a state where the projection portions 13 of one of the two first tubular components 10 were abutted against and fit to the recess portions 23 formed in one of both end portions of the tubular portion 21 of the second tubular component 20, and the projection portions 13 of the other of the two first tubular components 10 were abutted against and fit to the recess portions 23 formed in the other of both end portions of the tubular portion 21 of the second tubular component 20, the two first tubular components 10 and the second tubular component 20 were joined with each other for forming the composite cylinder member 1_{F}. For joining the two first tubular components 10 and the second tubular component 20, the adhesive elastic member 34 was disposed between the inner-circumference tubular portion 14 of the first tubular component 10 and the tubular portion 21 of the second tubular component 20. Note that the clearance dz between the end surface 11a of the tubular portion 11 of the first tubular component 10 and the end surface 21a of the tubular portion 21 of the second tubular component 20 was set at 0.2 mm. In addition, the elastic member 34 used is a silicone adhesive (i.e., elastic adhesive Super X made by CEMEDINE CO., LTD.) having the Shore A of rubber hardness of 43 degrees.

Since the composite cylinder member 1_{F} of the eighth example was formed as described above, the deterioration in accuracy caused by the thermal expansion was prevented even when the temperature changed, and the occurrence of the wobble was reduced.

### Modifications

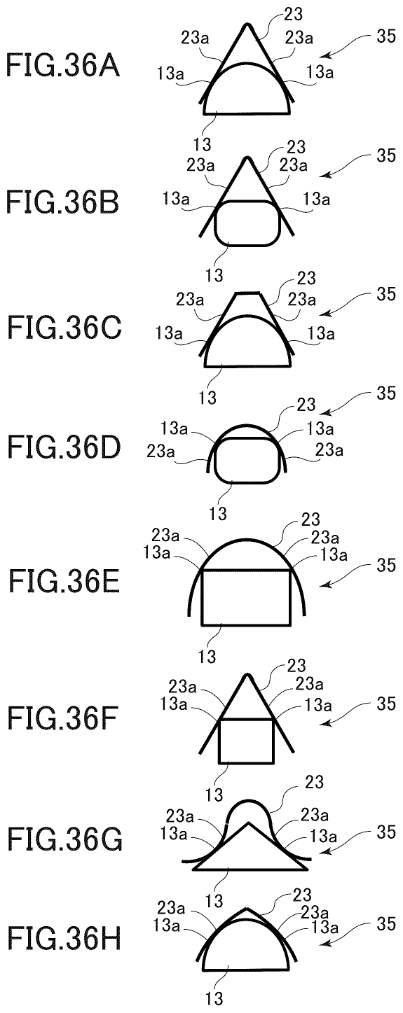

Next, modifications of the fit portion 35 (i.e., the projection portion 13 and the recess portion 23) of the fourth to the sixth embodiments and the eighth example will be described with reference to FIG. 36. FIG. 36A is a schematic diagram illustrating the projection portion and the recess portion of the composite cylinder member of the fourth embodiment. FIG. 36B is a schematic diagram illustrating a projection portion and a recess portion of a composite cylinder member of a first modification. FIG. 36C is a schematic diagram illustrating a projection portion and a recess portion of a composite cylinder member of a second modification. FIG. 36D is a schematic diagram illustrating a projection portion and a recess portion of a composite cylinder member of a third modification. FIG. 36E is a schematic diagram illustrating a projection portion and a recess portion of a composite cylinder member of a fourth modification. FIG. 36F is a schematic diagram illustrating a projection portion and a recess portion of a composite cylinder member of a fifth modification. FIG. 36G is a schematic diagram illustrating a projection portion and a recess portion of a composite cylinder member of a sixth modification. FIG. 36H is a schematic diagram illustrating a projection portion and a recess portion of a composite cylinder member of a seventh modification.

The fit portion 35 illustrated in FIG. 36A has the shape described in the fourth to the sixth embodiments and the eighth example. In the fit portion 35 of the first modification illustrated in FIG. 36B, unlike in the fit portion 35 illustrated in FIG. 36A, the projection portion 13 is formed so as to have an almost rectangular shape when viewed in the radial direction, and two corner portions of the rectangular shape on the recess portion 23 side are formed as the contact portions 13a having arc-shaped surfaces. Also in the first modification, when the first tubular component 10 thermally expanded or contracted due to the change in temperature, the abutment state between the contact portions 13a of the projection portion 13 and the contact portions (i.e., sloped surfaces) 23a of the recess portion 23 was kept, and the occurrence of the wobble of the first tubular component 10 and the second tubular component 20 was reduced.

In the fit portion 35 of the second modification illustrated in FIG. 36C, unlike in the fit portion 35 illustrated in FIG. 36A, the projection portion 13 has an almost semicircular shape when viewed in the radial direction, and two portions of the semicircular shape are formed as the contact portions 13a having arc-shaped surfaces. In addition, the recess portion 23 is formed such that when viewed in the radial direction, the clearance between the two sloped surfaces (i.e., the contact portions 23a) is increased in accordance with the shape of the projection portion 13. Also in the second modification, when the first tubular component 10 thermally expanded or contracted due to the change in temperature, the abutment state between the contact portions 13a of the projection portion 13 and the contact portions 23a of the recess portion 23 was kept. That is, the occurrence of the wobble of the first tubular component 10 and the second tubular component 20 was reduced.

In the fit portion 35 of the third modification illustrated in FIG. 36D, unlike in the fit portion 35 illustrated in FIG. 36A, the projection portion 13 has an almost rectangular shape when viewed in the radial direction, and two corner portions of the rectangular shape on the recess portion 23 side are formed as the contact portions 13a having arc-shaped surfaces. In addition, the recess portion 23 is formed so as to have an almost semicircular shape when viewed in the radial direction. Also in the third modification, when the first tubular component 10 thermally expanded or contracted due to the change in temperature, the abutment state between the contact portions 13a of the projection portion 13 and the contact portions 23a of the recess portion 23 was kept. That is, the occurrence of the wobble of the first tubular component 10 and the second tubular component 20 was reduced.

In the fit portion 35 of the fourth modification illustrated in FIG. 36E, unlike in the fit portion 35 illustrated in FIG. 36A, the projection portion 13 is formed so as to have an rectangular shape when viewed in the radial direction. In addition, the recess portion 23 is formed so as to have an almost semicircular shape when viewed in the radial direction. In the fourth modification, when the first tubular component 10 thermally expanded or contracted due to the change in temperature, the abutment state between the contact portions 13a of the projection portion 13 and the contact portions 23a of the recess portion 23 was not sufficiently kept. That is, the effect for reducing the wobble of the first tubular component 10 and the second tubular component 20 was produced in a narrow temperature range.

In the fit portion 35 of the fifth modification illustrated in FIG. 36F, unlike in the fit portion 35 illustrated in FIG. 36A, the projection portion 13 is formed so as to have an rectangular shape when viewed in the radial direction. In addition, the recess portion 23 is formed so as to have a triangular shape when viewed in the radial direction, and has two sloped surfaces (i.e., the contact portions 23a). In the fifth modification, when the first tubular component 10 thermally expanded or contracted due to the change in temperature, the abutment state between the contact portions 13a of the projection portion 13 and the contact portions 23a of the recess portion 23 was not sufficiently kept. That is, the effect for reducing the wobble of the first tubular component 10 and the second tubular component 20 was produced in a narrow temperature range.

In the fit portion 35 of the sixth modification illustrated in FIG. 36G, unlike in the fit portion 35 illustrated in FIG. 36A, the projection portion 13 is formed so as to have an almost triangular shape when viewed in the radial direction, and has two sloped surfaces (i.e., the contact portions 13a). In addition, the recess portion 23 is formed so as to have a curved shape when viewed in the radial direction, and has two arc-shaped surfaces (i.e., the contact portions 23a). In the sixth modification, although the effect for the temperature change has not been studied, it is supposed that when the first tubular component 10 thermally expands or contracts due to the change in temperature, the abutment state between the contact portions 13a of the projection portion 13 and the contact portions 23a of the recess portion 23 will be almost kept. That is, it is supposed that the occurrence of the wobble of the first tubular component 10 and the second tubular component 20 will be reduced.

In the fit portion 35 of the seventh modification illustrated in FIG. 36H, unlike in the fit portion 35 illustrated in FIG. 36A, the projection portion 13 is formed so as to have an almost semicircular shape when viewed in the radial direction, and has two arc-shaped contact portions 13a. In addition, the recess portion 23 is formed so as to have the contact portions 23a having two arc-shaped surfaces when viewed in the radial direction. In the seventh modification, although the effect for the temperature change has not been studied, it is supposed that when the first tubular component 10 thermally expands or contracts due to the change in temperature, the abutment state between the contact portions 13a of the projection portion 13 and the contact portions 23a of the recess portion 23 will be almost kept. That is, it is supposed that the occurrence of the wobble of the first tubular component 10 and the second tubular component 20 will be reduced.

### Feasibility of Other Embodiments

In the above-described first to sixth embodiments and first to eighth examples, each of the tubular portion 11 of the first tubular component 10 and the tubular portion 21 of the second tubular component 20 is formed like a cylinder whose cross section orthogonal to the axial direction is a circle. However, the present disclosure is not limited to this. For example, each of the tubular portion 11 of the first tubular component 10 and the tubular portion 21 of the second tubular component 20 may be formed like a cylinder whose shape in a cross section is an ellipse or a polygon (such as a triangle, a rectangle, a pentagon, or a hexagon). In addition, a portion of the first tubular component 10 other than the tubular portion 11 and a portion of the second tubular component 20 other than the tubular portion 21 may have any shape.

In the above-described first to third embodiments and first to seventh examples, the projecting portions 12 are formed in the tubular portion 11 of the first tubular component 10. However, the present disclosure is not limited to this. For example, the projecting portions (each having a tab shape) may be formed in the tubular portion 21 of the second tubular component 20, or the projecting portions (each having a tag shape) may be formed in both of the tubular portion 11 of the first tubular component 10 and the tubular portion 21 of the second tubular component 20. In particular, in a case where the projecting portions are formed in both of the tubular portion 11 of the first tubular component 10 and the tubular portion 21 of the second tubular component 20, the projecting portions may be formed alternately in the circumferential direction.

In the above-described fourth to sixth embodiments and eighth example, the projection portions 13 are formed in the tubular portion 11 of the first tubular component 10, and the recess portions 23 are formed in the tubular portion 21 of the second tubular component 20. However, the present disclosure is not limited to this. For example, the projection portions may be formed in the tubular portion 21 of the second tubular component 20, and the recess portions may be formed in the tubular portion 21 of the second tubular component 20. That is, the projection portions have only to be formed in one of the tubular portion 11 of the first tubular component 10 and the tubular portion 21 of the second tubular component 20, and the recess portions have only to be formed in the other. In addition, although the description has been made for the case where a projection portion 13 and a corresponding recess portion 23 are in contact with each other at two positions (i.e., two contacts), the present disclosure is not limited to this. For example, a projection portion 13 and a corresponding recess portion 23 may be in contact with each other at three or more positions (i.e., three or more contacts).

### OTHER EMBODIMENTS

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-196162, filed Nov. 17, 2023, which is hereby incorporated by reference herein in its entirety.

What is claimed is:

1. A member comprising:
a first tubular component including a tubular portion having a tubular shape; and
a second tubular component including a tubular portion having a tubular shape and disposed coaxially with the first tubular component;
wherein the first tubular component includes a plurality of projecting portions configured to project from one end of the tubular portion of the first tubular component in an axial direction and spaced from each other in a circumferential direction,
wherein the first tubular component and the second tubular component are joined with each other such that each of the plurality of projecting portions is joined with the second tubular component, and
wherein each of the plurality of projecting portions includes a distal end portion joined with the second tubular component and a base portion separated from the second tubular component.

2. The member according to claim 1, wherein the base portion is separated from the second tubular component in an axial direction.

3. The member according to claim 1, wherein the base portion is separated from the second tubular component in a radial direction.

4. The member according to claim 1, wherein the second tubular component is a continuous-carbon-fiber reinforced molded resin body.

5. The member according to claim 1, wherein a thickness of each of the plurality of projecting portions is smaller than a thickness of the tubular portion of the first tubular component in a radial direction.

6. The member according to claim 1, wherein each of the tubular portion of the first tubular component and the tubular portion of the second tubular component has a cylindrical shape.

7. The member according to claim 1, wherein a coefficient of linear expansion of the first tubular component and a coefficient of linear expansion of the second tubular component are different from each other.

8. The member according to claim 1, wherein a main component of the first tubular component and a main component of the second tubular component are an identical resin material.

9. The member according to claim 8, wherein the main component of the first tubular component and the main component of the second tubular component are polycarbonate.

10. The member according to claim 8, wherein each of the plurality of projecting portions is joined with the second tubular component by thermal welding.

11. A method of manufacturing a member, the method comprising:
providing a first tubular component including a tubular portion having a tubular shape and a second tubular component including a tubular portion having a tubular shape and disposed coaxially with the first tubular component, the first tubular component including a plurality of projecting portions projecting from one end of the tubular portion of the first tubular component in an axial direction and spaced from each other in a circumferential direction; and
joining each of the plurality of projecting portions with the second tubular component such that a distal end portion of each of the plurality of projecting portions is joined with the second tubular component and a base portion of each of the plurality of projecting portions is separated from the second tubular component.

12. A member comprising:
a base component;
a first tubular component that has a tubular shape, that includes a tubular portion including a first end surface, and that is supported by the base component; and
a second tubular component that has a tubular shape, that includes a tubular portion including a second end surface, and that is supported by the base component,
wherein the first tubular component is made of a material whose coefficient of linear expansion is higher than that of the second tubular component,
wherein one of the tubular portion of the first tubular component or the tubular portion of the second tubular component includes a projection portion that projects from the first end surface or the second end surface,
wherein the other of the one of the tubular portion of the first tubular component or the tubular portion of the second tubular component includes a recess portion that is recessed from the first end surface or the second end surface, and that is in contact with the projection portion at at least two positions, and
wherein the first tubular component and the second tubular component are joined with each other such that
a first clearance is formed between the first end surface and the second end surface for allowing relative movement between the first end surface and the second end surface in a direction in which the first end surface and the second end surface face each other, in a case where the base component and the first tubular component relatively expand or contract with respect to the second tubular component due to change in temperature, and
a contact state between the projection portion and the recess portion is kept even if the first end surface and the second end surface are relatively moved with respect to each other in the direction in which the first end surface and the second end surface face each other, by one of the projection portion and the recess portion expanding or contracting with respect to another.

13. The member according to claim 12, wherein the first tubular component includes the projection portion that projects from the first end surface,
wherein the second tubular component includes the recess portion that is recessed from the second end surface,
wherein in a case where the temperature lowers, even if the first end surface is moved closer to the second end surface in the direction in which the first end surface and the second end surface face each other, the projection portion formed in the first tubular component relatively contracts with respect to the recess portion formed in the second tubular component, so that the contact state between the projection portion and the recess portion is kept, and
wherein in a case where the temperature rises, even if the first end surface is moved away from the second end surface in the direction in which the first end surface and the second end surface face each other, the projection portion formed in the first tubular component expands with respect to the recess portion formed in the second tubular component, so that the contact state between the projection portion and the recess portion is kept.

14. The member according to claim 12, wherein the second tubular component has a cylindrical shape,
wherein the first tubular component has a cylindrical shape, and disposed coaxially with the second tubular component, and
wherein the direction in which the first end surface and the second end surface face each other is an axial direction.

15. The member according to claim 12, wherein the second tubular component is a continuous-carbon-fiber reinforced molded resin body, and
wherein the first tubular component is a molded resin product.

16. The member according to claim 12, wherein the recess portion includes two sloped surfaces that form a shape that broadens toward a direction toward which the recess portion is opened in the direction in which the first end surface and the second end surface face each other,
wherein the projection portion has a shape that narrows toward a direction toward which the projection portion projects in the direction in which the first end surface and the second end surface face each other, and includes two arc-shaped surfaces that are in contact with the corresponding two sloped surfaces, and
wherein the projection portion and the recess portion are in contact with each other at two positions, via the two sloped surfaces and the two arc-shaped surfaces.

17. The member according to claim 16, further comprising:
a joint portion configured to join the first tubular component and the second tubular component at a position at which two imaginary planes intersect with each other, one of the two imaginary planes including one of the two sloped surfaces, the other of the two imaginary planes including the other of the two sloped surfaces.

18. The member according to claim 12, wherein the first tubular component and the second tubular component are disposed in a state where a second clearance is cylindrically formed in a circumferential direction.

19. The member according to claim 18, further comprising an elastic member disposed in the second clearance and having Shore A of rubber hardness of 20 to 80 degrees.

20. A method of manufacturing a member, the method comprising:
providing:
a base component,
a first tubular component that has a tubular shape, that includes a tubular portion including a first end surface, and that is supported by the base component, and
a second tubular component that has a tubular shape, that includes a tubular portion including a second end surface, that is made of a material whose coefficient of linear expansion is higher than that of the first tubular component, and that is supported by the base component,
wherein one of the tubular portion of the first tubular component or the tubular portion of the second tubular component includes a projection portion that projects from the first end surface or the second end surface,
wherein the other of the one of the tubular portion of the first tubular component or the tubular portion of the second tubular component includes a recess portion that is recessed from the first end surface or the second end surface, and that is in contact with the projection portion at at least two positions; and
joining the first tubular component and the second tubular component such that:
a first clearance is formed between the first end surface and the second end surface for allowing relative movement between the first end surface and the second end surface in a direction in which the first end surface and the second end surface face each other, in a case where the base component and the second tubular component relatively expand or contract with respect to the first tubular component due to change in temperature, and
a contact state between the projection portion and the recess portion is kept even if the first end surface and the second end surface are relatively moved with respect to each other in the direction in which the first end surface and the second end surface face each other, by one of the projection portion or the recess portion expanding or contracting with respect to another.

21. An apparatus comprising:
a member according to claim 1; and
at least one element enclosed by at least one of the first tubular component or the second tubular component of the member.
